(19) United States
(12) Patent Application Publication
(10) Pub. No.: US 2024/0169286 A1
(43) Pub. Date: May 23, 2024

(54) VIDEO MARKUP SYSTEM

(71) Applicant: MiView Integrated Solutions, LLC, Carrollton, TX (US)

(72) Inventor: Luis A. URIARTE, Frisco, TX (US)

(21) Appl. No.: 18/424,544

(22) Filed: Jan. 26, 2024

Related U.S. Application Data
(63) Continuation-in-part of application No. 17/944,913, filed on Sep. 14, 2022.
Application No. 17/944,913 is a continuation of application No. 17/351,982, filed on Jun. 18, 2021, now Pat. No. 11,481,702.
(60) Provisional application No. 63/529,484, filed on Jul. 28, 2023.
(60) Provisional application No. 63/208,739, filed on Jun. 9, 2021.
(60) Provisional application No. 63/040,908, filed on Jun. 18, 2020.

(51) Int. Cl. G06Q 10/0631; G06Q 10/0875; G06Q 10/10; G06Q 50/08

(52) U.S. Cl. CPC G06Q 10/063114; G06Q 10/063116; G06Q 10/063118; G06Q 10/0875; G06Q 10/103; G06Q 50/08

(57) ABSTRACT

A method implements a video markup system. The method includes presenting a checklist item and receiving an evaluation video documenting an element of a worksite corresponding to the checklist item. The method further includes receiving an evaluation picture from the evaluation video. The evaluation picture documents an element issue portrayed in the evaluation video. The method further includes receiving contextual data of the evaluation picture. The contextual data of the evaluation picture includes markup data of the evaluation picture. The method further includes using the evaluation video and the evaluation picture to update the checklist item to an evaluated checklist item.

### CROSS REFERENCE TO RELATED APPLICATIONS

This application claims the benefit of U.S. Provisional Application 63/529,484, filed Jul. 28, 2023. This application is a continuation in part of U.S. application Ser. No. 17/944,913, filed Sep. 14, 2022. U.S. application Ser. No. 17/944,913 is a continuation of U.S. application Ser. No. 17/351,982, filed Jun. 18, 2021. U.S. application Ser. No. 17/351,982 claims the benefit of U.S. Provisional Application 63/208,739, filed Jun. 9, 2021. U.S. application Ser. No. 17/351,982 claims the benefit of U.S. Provisional Application 63/040,908, filed Jun. 18, 2020. The applications listed above are incorporated herein by reference to the extent allowed by applicable rules and law.

### BACKGROUND

Applications may be used to provide checklists and track the progress of tasks performed for projects at worksites. The applications may be web-based and accessible through a website, using a mobile device application, etc. Video may be recorded using mobile devices and other equipment connected to mobile devices to document the progress of tasks. A challenge with using video is that the video may not provide sufficient context for the recording.

### SUMMARY

In general, in one or more aspects, the disclosure relates to a method that implements a video markup system. The method includes presenting a checklist item and receiving an evaluation video documenting an element of a worksite corresponding to the checklist item. The method further includes receiving an evaluation picture from the evaluation video. The evaluation picture documents an element issue portrayed in the evaluation video. The method further includes receiving contextual data of the evaluation picture. The contextual data of the evaluation picture includes markup data of the evaluation picture. The method further includes using the evaluation video and the evaluation picture to update the checklist item to an evaluated checklist item.

In general, in one or more aspects, the disclosure relates to a system that implements a video markup. The system includes at least one processor and an application that executes on the at least one processor. The application performs presenting a checklist item and receiving an evaluation video documenting an element of a worksite corresponding to the checklist item. The application further performs receiving an evaluation picture from the evaluation video. The evaluation picture documents an element issue portrayed in the evaluation video. The application further performs receiving contextual data of the evaluation picture. The contextual data of the evaluation picture includes markup data of the evaluation picture. The application further performs using the evaluation video and the evaluation picture to update the checklist item to an evaluated checklist item.

In general, in one or more aspects, the disclosure relates to a non-transitory computer readable medium with instructions that may execute on one or more processors. Execution of the instructions may perform presenting a checklist item and receiving an evaluation video documenting an element of a worksite corresponding to the checklist item. Execution of the instructions may further perform receiving an evaluation picture from the evaluation video. The evaluation picture documents an element issue portrayed in the evaluation video. Execution of the instructions may further perform receiving contextual data of the evaluation picture. The contextual data of the evaluation picture includes markup data of the evaluation picture. Execution of the instructions may further perform using the evaluation video and the evaluation picture to update the checklist item to an evaluated checklist item.

Other aspects of the one or more embodiments may be apparent from the following description and the appended claims.

### BRIEF DESCRIPTION OF DRAWINGS

FIG. 1, FIG. 2A, FIG. 2B, and FIG. 2C show diagrams in accordance with one or more embodiments.

FIG. 3A and FIG. 3B show methods in accordance with one or more embodiments.

FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, FIG. 26, FIG. 27, FIG. 28, FIG. 29, FIG. 30, FIG. 31, FIG. 32, FIG. 33, FIG. 34, FIG. 35, FIG. 36, FIG. 37, FIG. 38, FIG. 39, FIG. 40, FIG. 41, FIG. 42, FIG. 43, FIG. 44, FIG. 45, FIG. 46, FIG. 47, FIG. 48, FIG. 49, FIG. 50, FIG. 51, FIG. 52, and FIG. 53 show examples of apparatus, systems, and methods in accordance with the disclosure.

FIG. 54A and FIG. 54B show a computing system and network environment, in accordance with one or more embodiments of the disclosure.

Similar elements in the various figures are denoted by similar names and reference numerals. The features and elements described in one figure may extend to similarly named features and elements in different figures.

### DETAILED DESCRIPTION

Embodiments of disclosure provide a video markup system that provides context for recordings, which may be used to document the performance of tasks and the status of elements being worked on of work at a worksite. In an embodiment, a user application may present a checklist item on a computing device, such as a smartphone, which may be an evaluation device.

The evaluation device records an evaluation video and generates an evaluation picture to document issues with elements that are worked on as part of the checklist item at a worksite. Contextual data is received that includes markup data to identify an issue at the worksite. For example, if a pipe or cable is installed in the wrong place, a video may be recorded with a picture taken from the video to show the installation of the pipe or cable. The user may mark up the picture, e.g., by drawing a circle around the pipe or cable, to highlight or identify the issue and provide descriptive text.

The checklist item may be updated to indicate that the task is not complete. After work is performed to resolve the issue, a reviewer using a reviewer device may capture a review video with a review picture and additional markup to show that the issue is resolved.

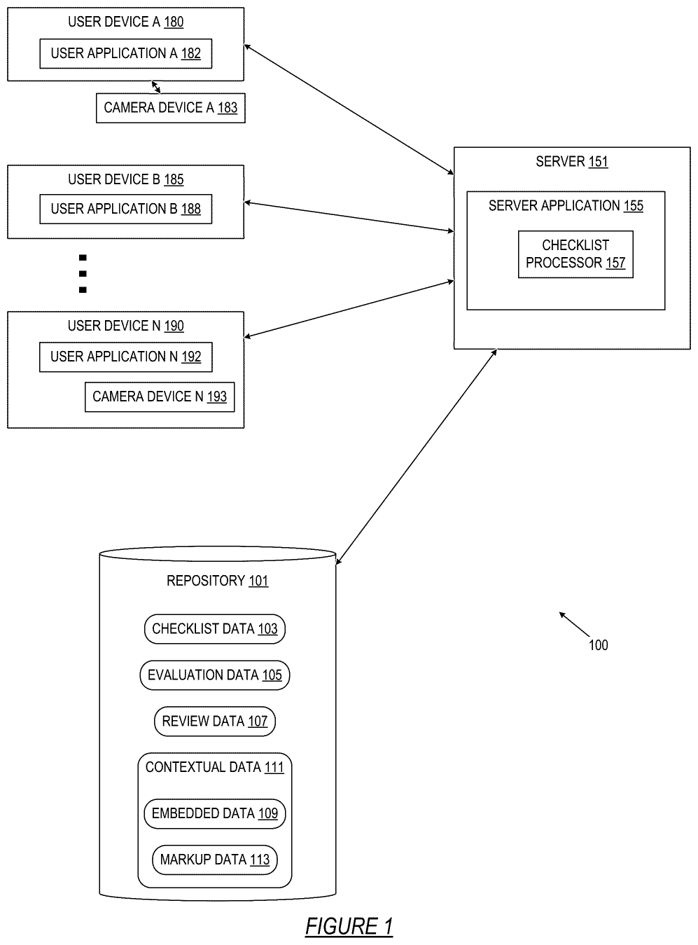

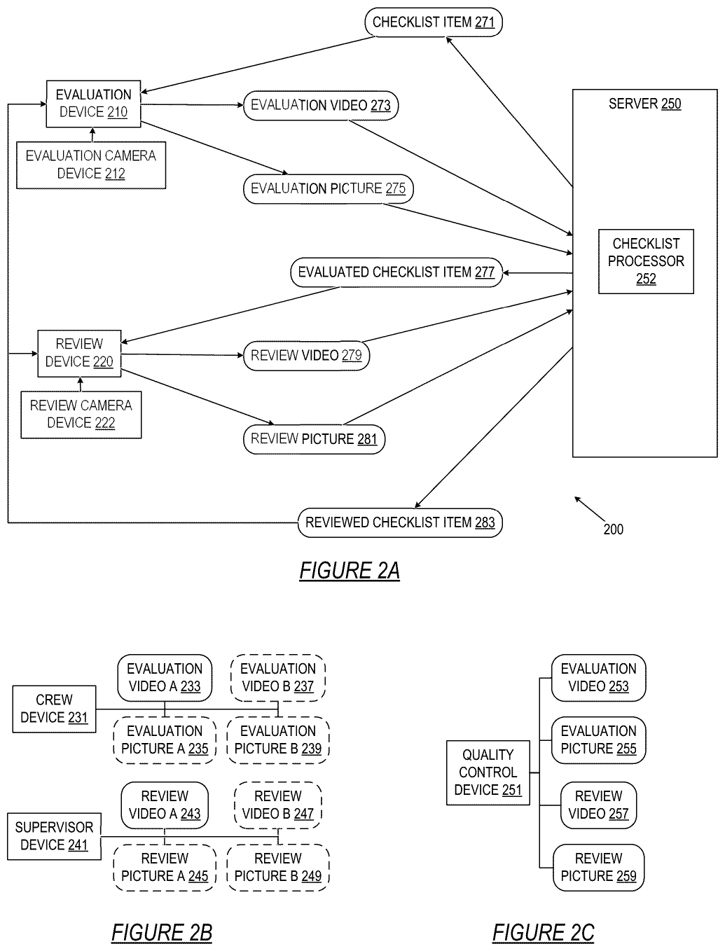

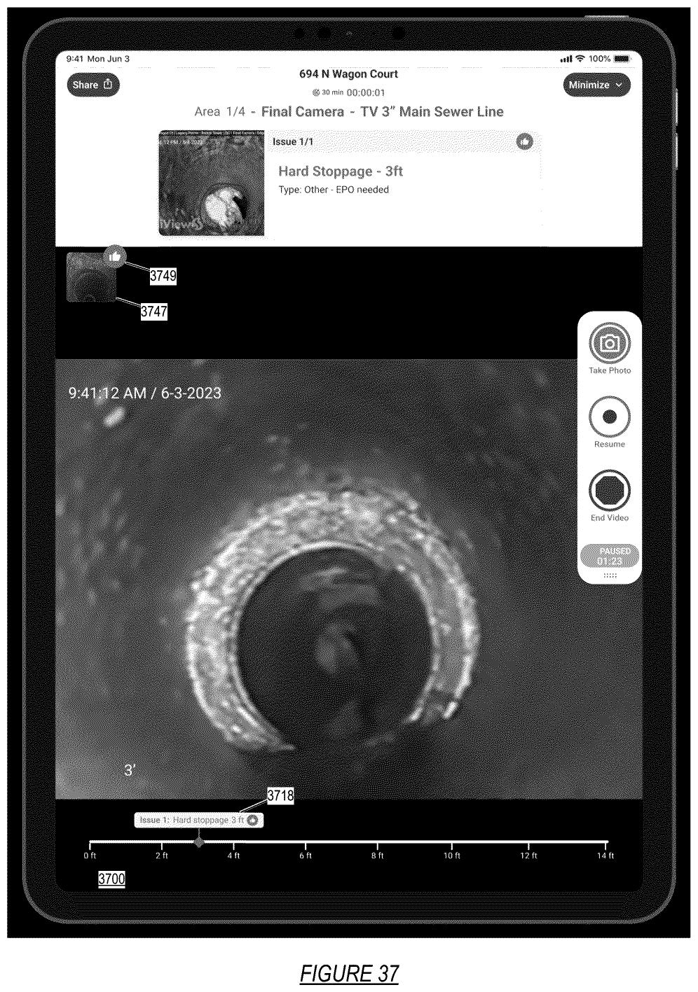

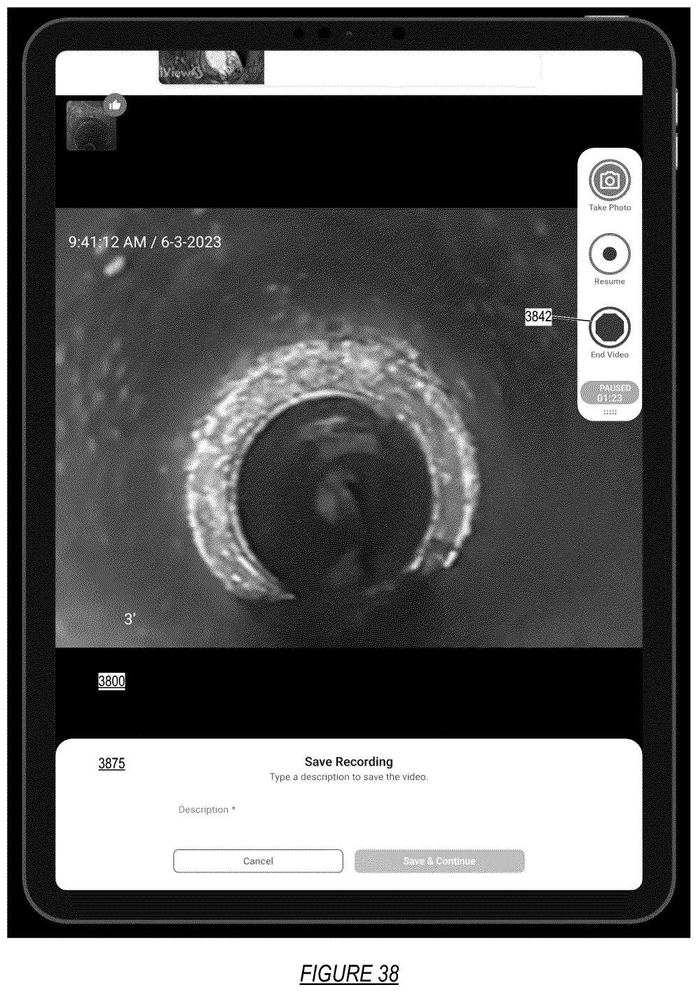

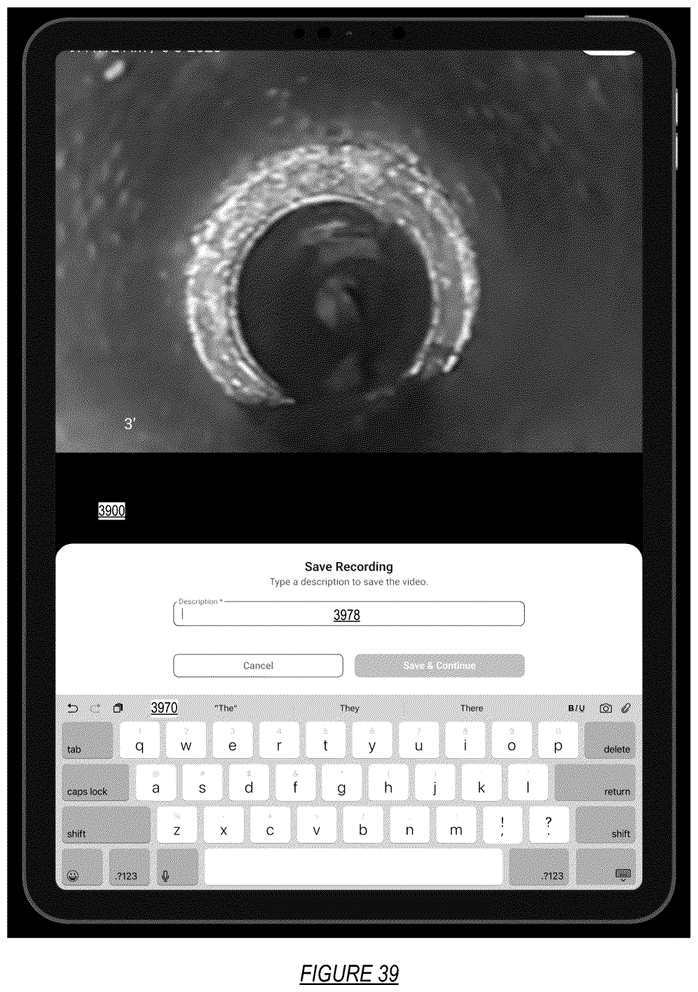

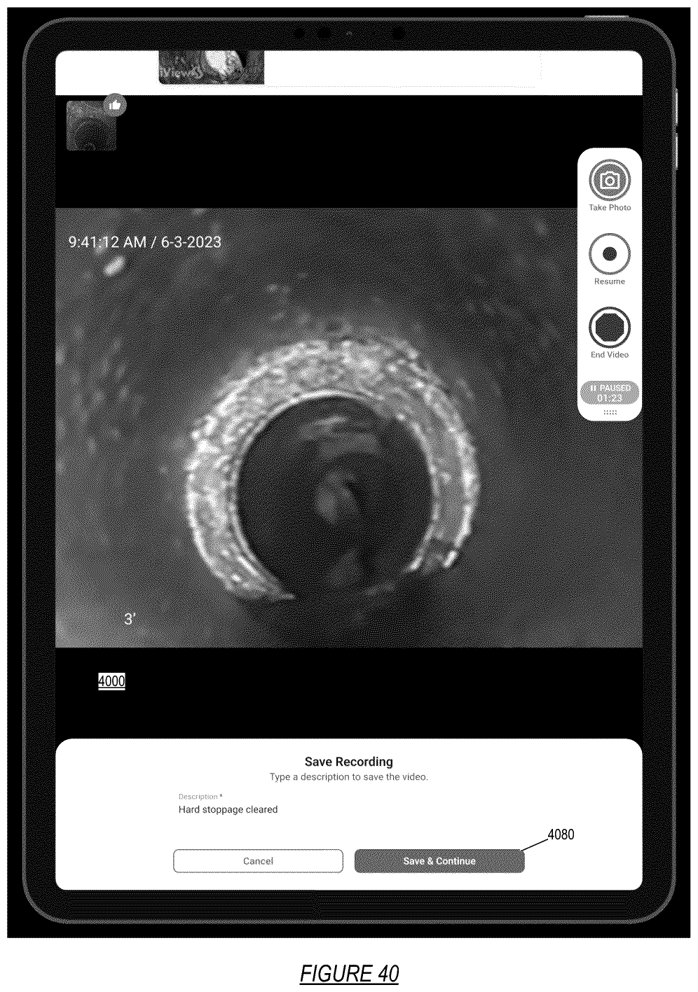

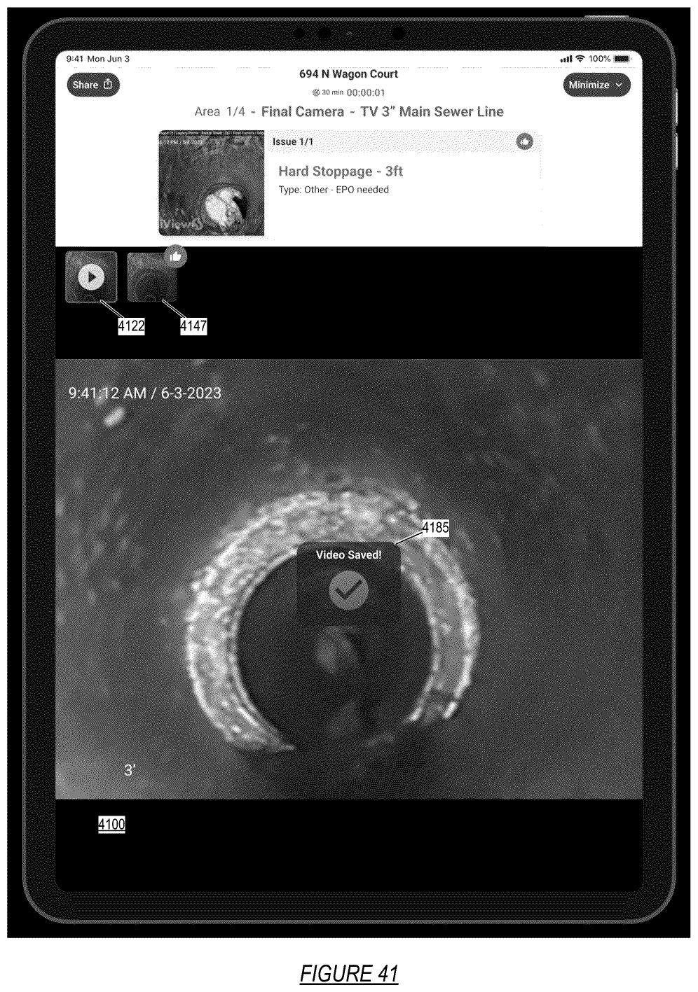

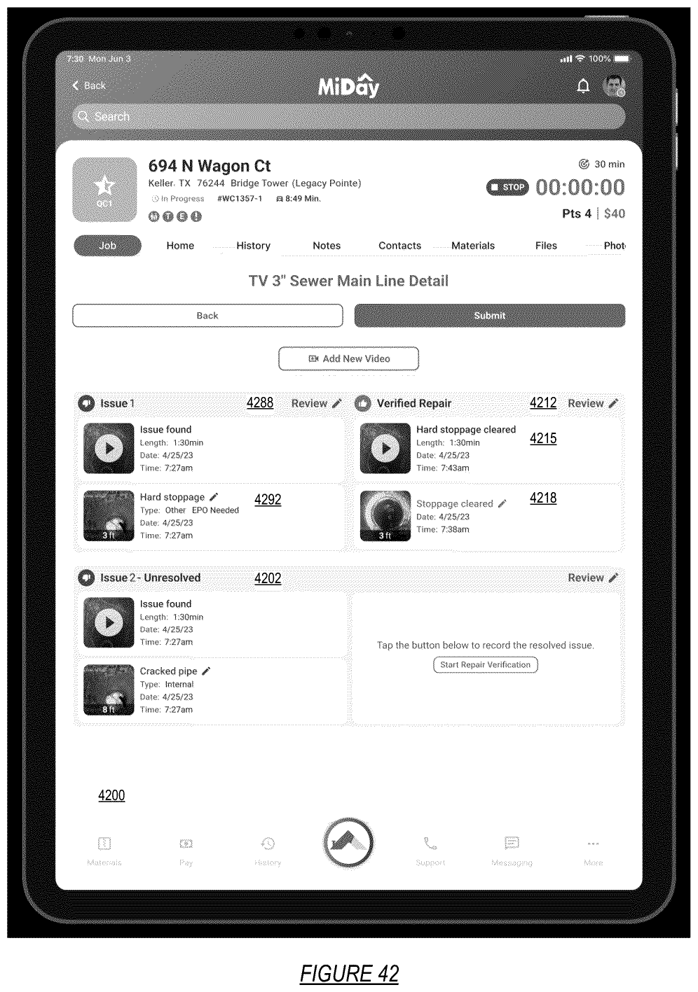

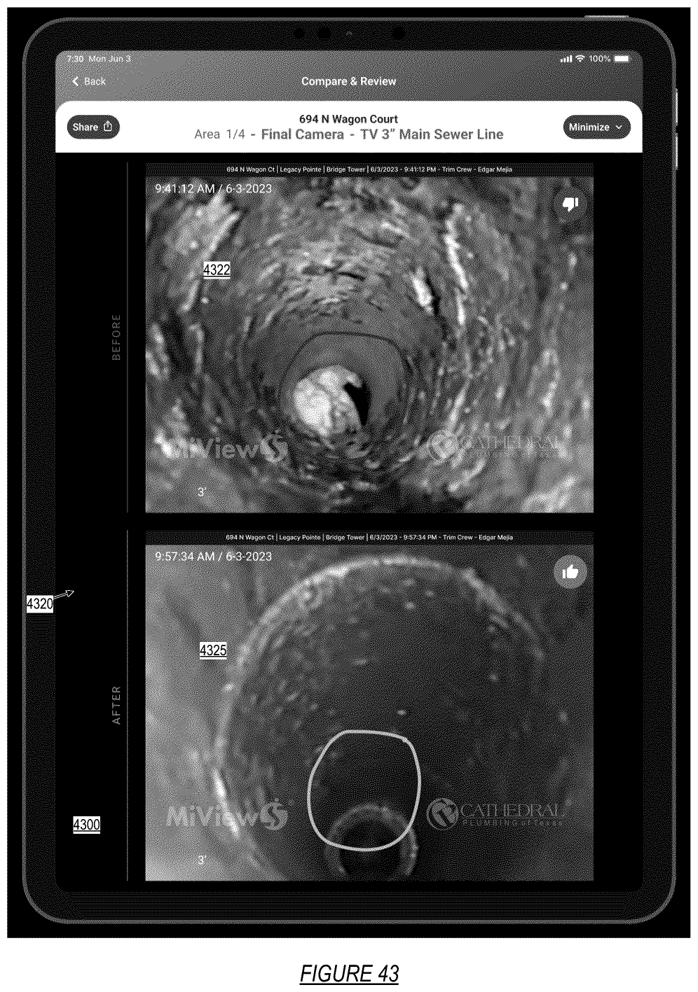

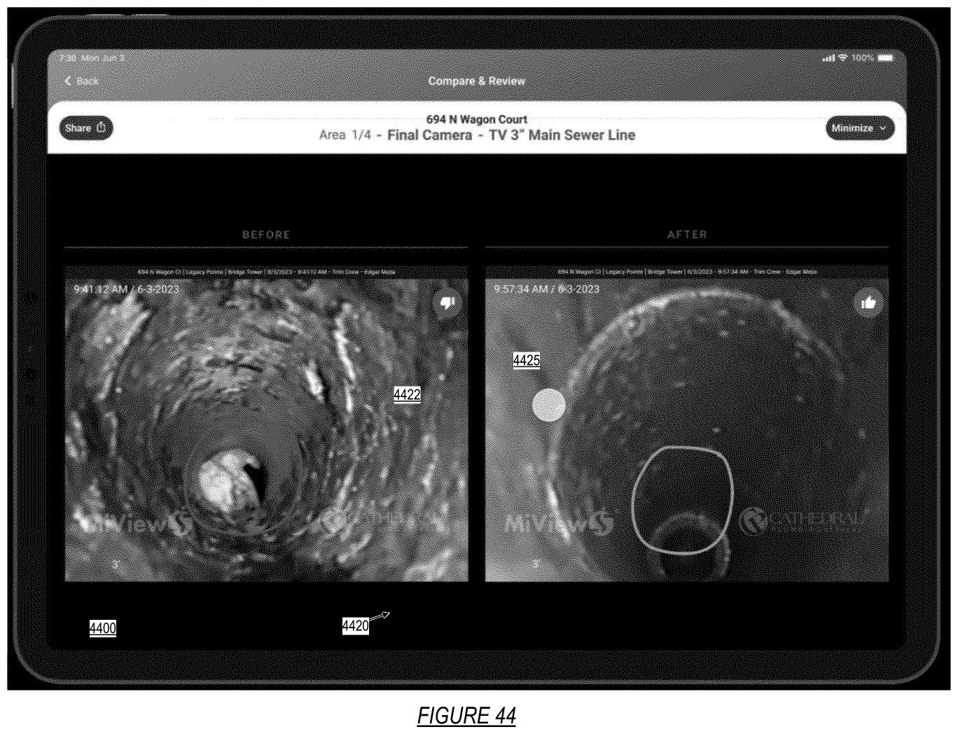

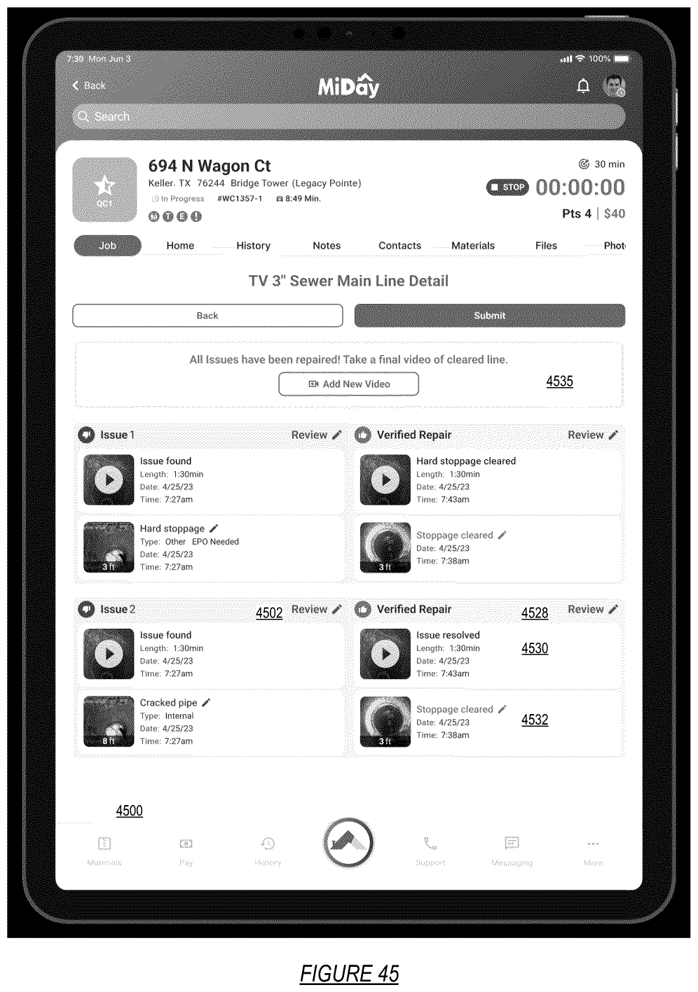

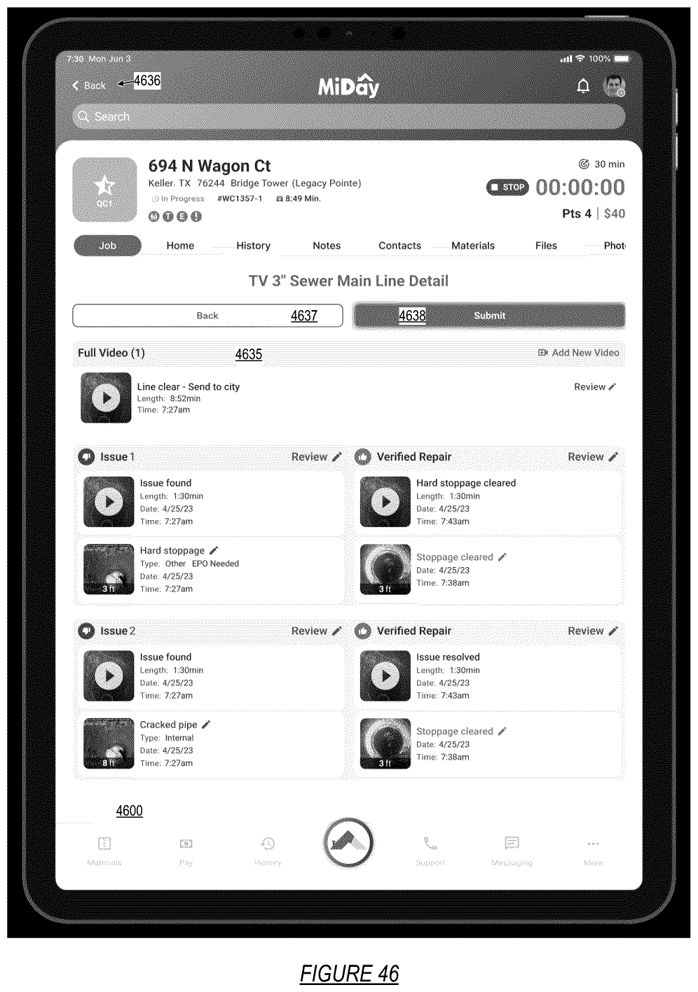

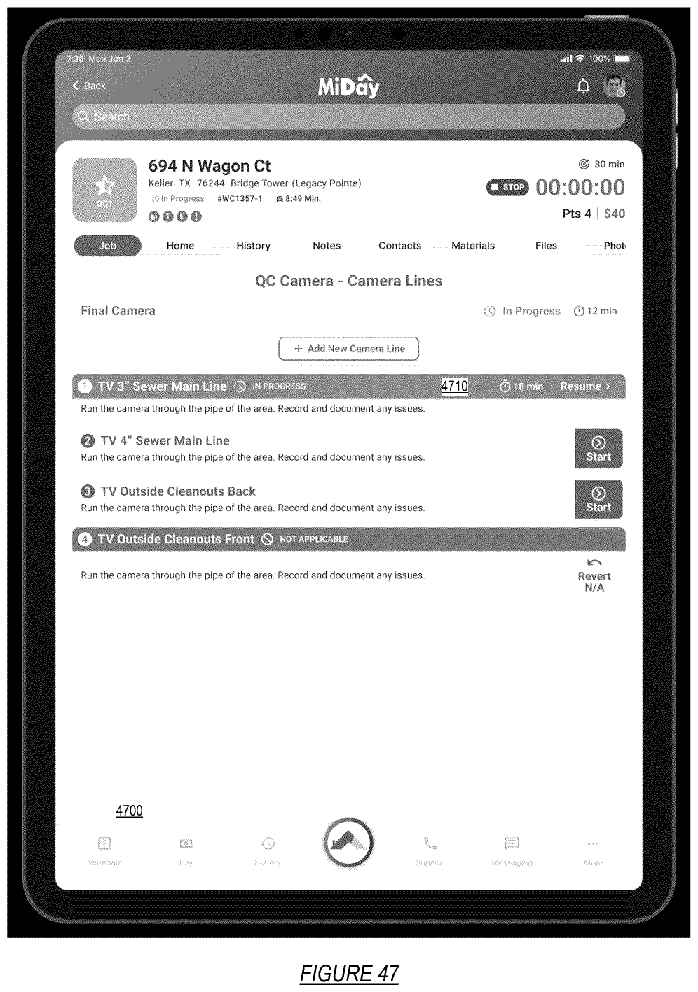

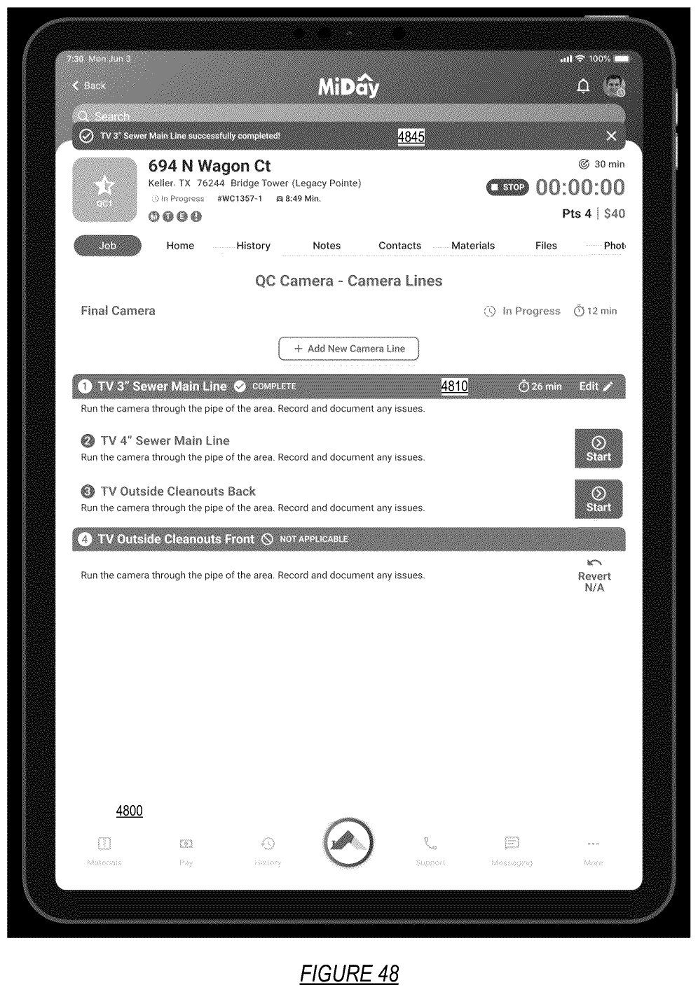

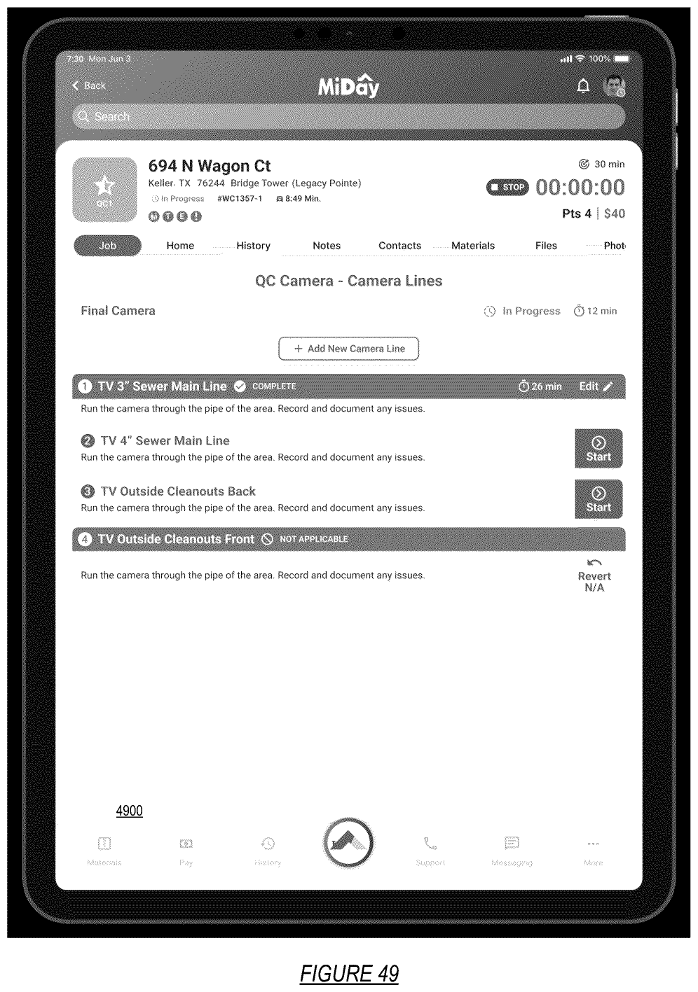

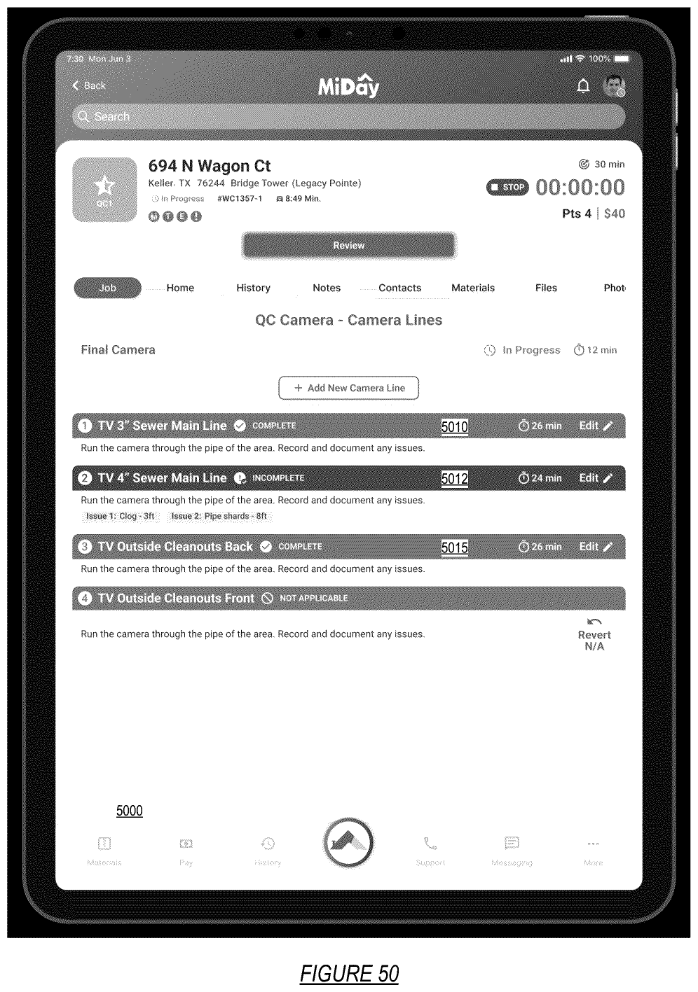

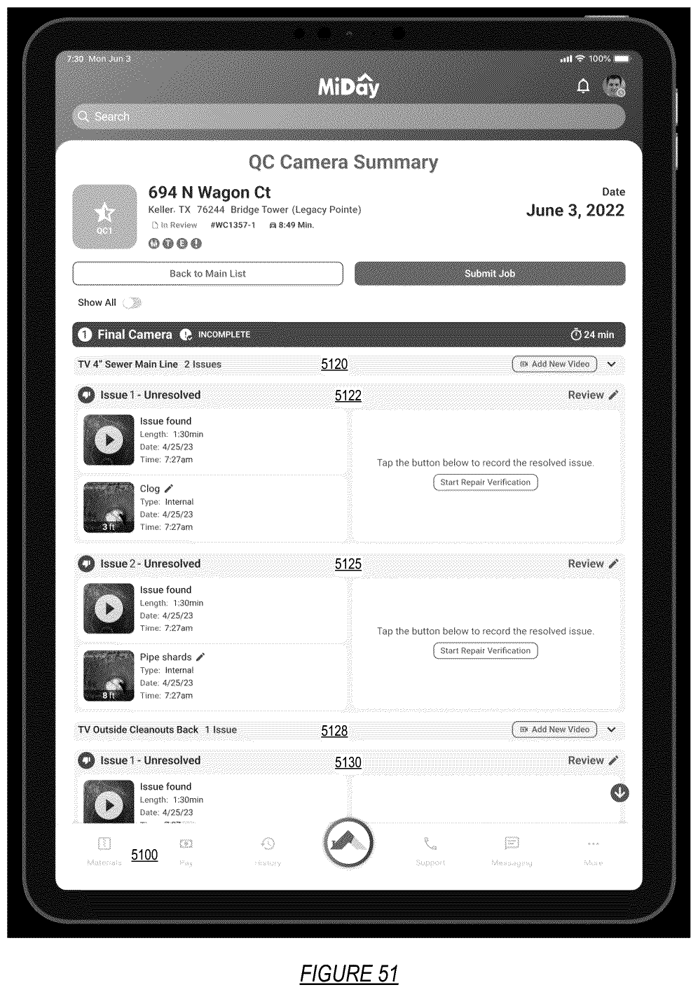

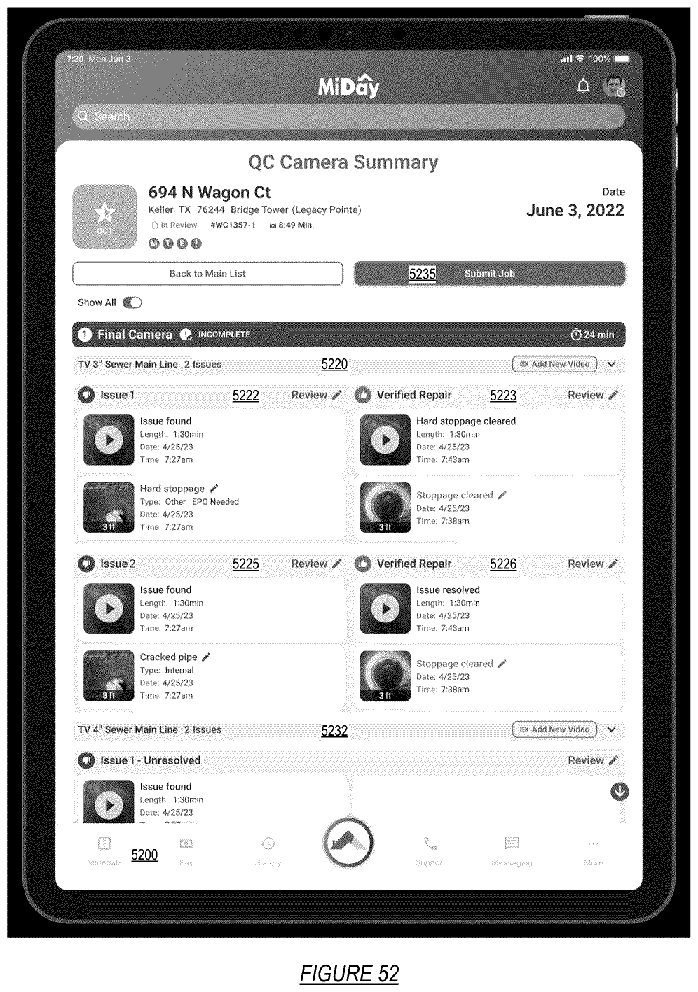

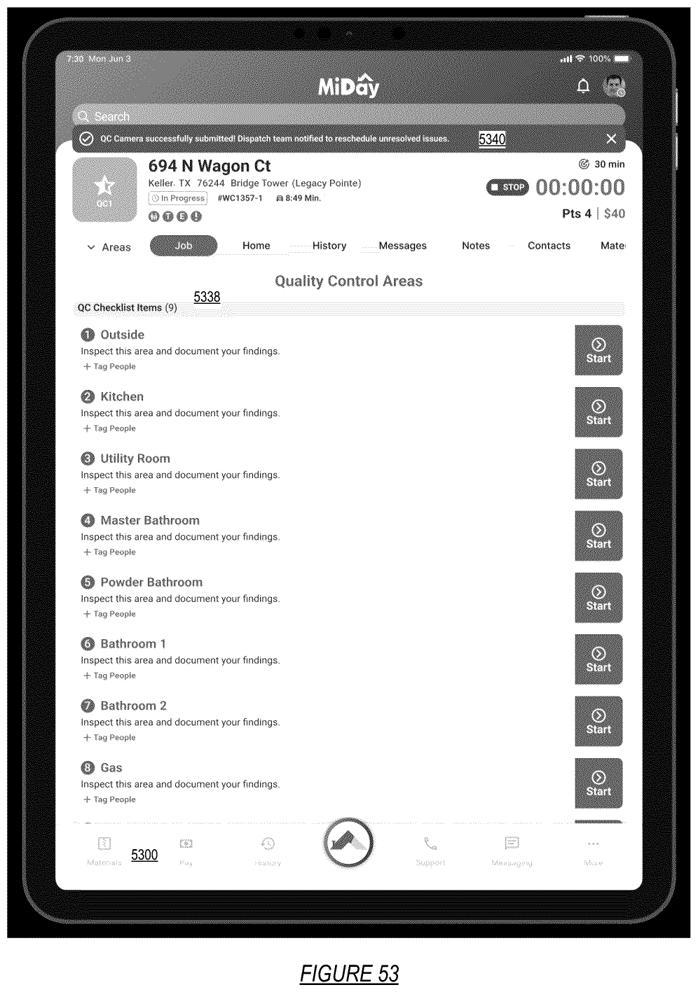

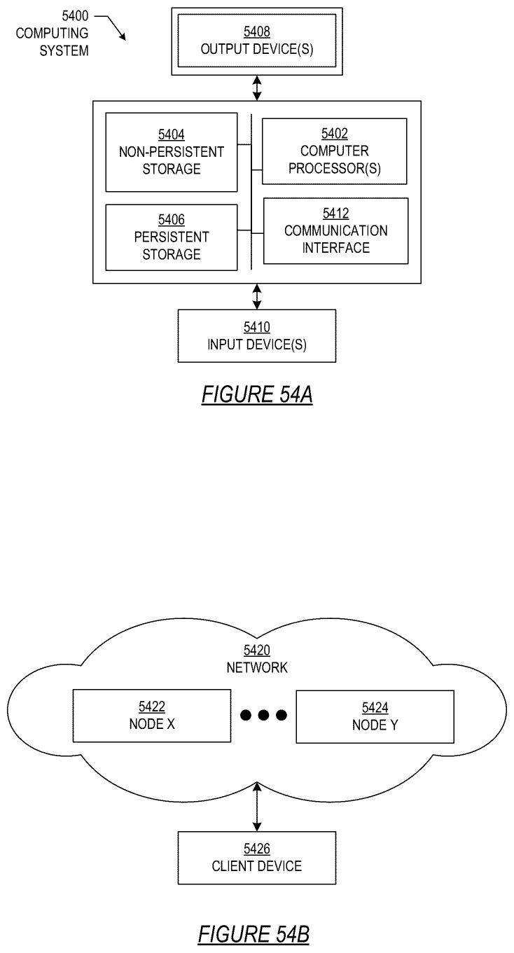

Turning to FIG. 1, the system (100) provides the capabilities of a video markup system to take visual media and mark up specific areas using computing systems described in FIG. 54A and FIG. 54B. Videos and other visual media are viewable, reviewable, recordable, etc. from the user applications A (182) and B (188) through N (192) and may correspond to items in checklists displayed with the user applications A (182) and B (188) through N (192). The user applications A (182) and B (188) through N (192) may be operated on the user devices A (180) and B (185) through N (190), which may be mobile devices, tablet devices, desktop devices, etc.

The markup may be applied to different formats and types of visual media, including media stored as photos, videos, computer aided design (CAD) files, printable files (e.g., PDFs), etc. The media may be stored in the repository (101).

The repository (101) is a type of storage unit and/or device (e.g., a file system, database, data structure, or any other storage mechanism) for storing data. The repository (101) may include multiple different, potentially heterogeneous, storage units and/or devices. The repository (101) stores data utilized by other components of the system (100). The data stored by the repository (101) includes the checklist data (103), the evaluation data (105), the review data (107), the embedded data (109), the contextual data (111), the markup data (113), etc.

The checklist data (103) may include information for checklists that may be processed by the server (151) displayed by the user devices A (180) and B (185) through N (190). In an embodiment, a checklist may correspond to a physical address of a worksite and provide a list of tasks to be completed at the worksite. Items in the checklist may indicate that a video is to be recorded in order for the checklist items to be identified as complete. The checklist data (103) may include descriptions of work to be performed at the worksite, include descriptions of the expected contents of videos for evaluation and review of the work performed, and include statuses of the checklist items. Description of the expected contents may identify elements at the worksite that are to be captured in videos for the checklist data (103). An element may be a tangible object at the worksite, such as framing, flooring, cables, pipes, etc.

The evaluation data (105) includes information for the evaluation of the completion of the checklist items of the checklist data (103). In an embodiment, the evaluation data (105) may include evaluation videos and evaluation pictures captured at a worksite that portray elements at the worksite from which the status of the checklist items may be identified. The evaluation data (105) may include or correspond to portions of the embedded data (109), the contextual data (111), and the markup data (113). For example, an evaluation video and evaluation picture may show that a pipe has been properly installed at the worksite. The evaluation data (105) may further identify issues with the elements, referred to as element issues. For example, a portion of the evaluation data (105) may identify that a cable was installed in an improper location or that a pipe has a clog.

The review data (107) includes information for the review of the completion of the checklist items of the checklist data (103). In an embodiment, review data (107) may include review videos and review pictures captured at the worksite. The review videos and review pictures may show that element issues identified with evaluation videos and evaluation pictures have been resolved. For example, an evaluation video and evaluation picture may show improper installation of framing at the worksite. The corresponding review video and review picture may show that the framing is properly reinstalled.

In one embodiment, an existing video may be imported. The imported video may be processed by the system (100) in response to user inputs similar to the processing of a live video such as the evaluation video or review video.

The contextual data (111) includes information that may identify additional context for the videos and pictures used by the system (100). In an embodiment, the contextual data (111) may include the embedded data (109), the markup data (113), data about the location of the worksite and the application used to capture the videos and pictures, etc. For example, contextual data may include data in overlays onto the videos and pictures that identify the physical address of the worksite, the name of the community at which the worksite is located, the name of the builder responsible for the community, etc. The contextual data additionally include watermarks incorporated within the videos and pictures that may identify the application being used to record and transmit the video and pictures and may identify an organization that performs work at the worksite. The contextual data (111) may further include descriptions of issues found at worksites and documented with the system (100).

The embedded data (109) includes information that may be embedded in the videos and pictures used by the system (100). In an embodiment, the embedded data (109) may include timestamps identifying when the videos and pictures are recorded, location information identifying the location of the device that recorded the videos and pictures, and additional information. In an embodiment, the additional information may be provided by the device recording the video or pictures and be relevant to the video or pictures. For example, a pipe evaluation device may include a camera at the end of a plumbing snake and the pipe evaluation device may provide additional data that identifies how far the camera and plumbing snake have been extended into a pipe.

The markup data (113) includes information that may be integrated into the videos and pictures to identify element issues within the videos and pictures. For example, the markup data (113) may include a circle drawn around a clog and a pipe portrayed in a video or picture of the pipe.

Continuing with FIG. 1, the system (100) also may include the server (151). The server (151) is one or more computing systems, which may be in a distributed computing environment. The server (151) may host and/or execute one or more processes, software, applications, etc. For example, the server (151) may execute one or multiple instantiations of the server application (155) using different computing systems and servers. The server (151) may interact with the user devices A (180) and B (185) through N (190) to provide video markup services.

The server application (155) is a collection of programs operating on the server (151). In an embodiment, the server application (155) uses the checklist processor (157) to update checklists and checklist items displayed to the user devices A (180) and B (185) through N (190) responsive to the videos, pictures, and data captured by or through the user devices A (180) and B (185) through N (190).

The checklist processor (157) is a program operating as part of the server application (155) and executing on the server (151). The checklist processor (157) maintains the statuses of the checklist items and checklists served to the user devices A (180) and B (185) through N (190). The checklist processor (157) may transmit checklist items to the user devices A (180) and B (185) through N (190) and receive videos, pictures, and data from the user devices A (180) and B (185) through N (190). When a checklist item is updated, the checklist processor (157) may transmit notifications to the user devices A (180) and B (185) through N (190) to update the users of the system with real-time data.

Continuing with FIG. 1, the user devices A (180) and B (185) through N (190) may interact with the server (151). The user devices A (180) and B (185) through N (190) may be computing systems in accordance with FIG. 54A and FIG. 54B and be connected with or include the camera devices A (183) through N (193). The user devices A (180) and B (185) through N (190) may include and execute the user applications A (182) and B (188) through N (192).

The user applications A (182) and B (188) through N (192) are operated by users to view and update items of checklists and record videos, pictures, and data with user interfaces. The checklists, videos, pictures, and data are transferred between the user applications A (182) and B (188) through N (192) and the server (151) using standardized network protocols, which may include transferring data using messages conforming to the hypertext transfer protocol (HTTP), the HTTP secure (HTTPS) protocol, and additional protocols to transmit the checklists, videos, pictures, data, etc., between devices.

The user interfaces of the user devices A (180) and B (185) through N (190) may use multiple methods of input. For example, the methods of input may include button presses, audio commands, etc. The use of audio commands may provide an alternative for users whose hands are full or dirty.

The camera devices A (183) and N (193) include the cameras used to capture the video and pictures. The camera devices (183) and (193) may be external and separate from the user devices A (180) and B (185) through N (190) connected by wire or wireless connections or may be integrated with the user devices A (180) and B (185) through N (190).

In one embodiment, the user device A (180) is connected to the camera device A (183), which is separate from the user device A (180). For example, the camera device A (183) may be a pipeline inspection device that includes a camera at the end of a plumbing snake that connects to the user device A (180) via a short-range wireless connection (e.g., Bluetooth).

In one embodiment, the user device N (190) incorporates the camera device N (193) as a part of the user device N (190). For example, the camera device N (193) may be a camera integrated into a smartphone or tablet device.

Although described within the context of a client server environment with servers and user devices, aspects of the disclosure may be practiced with a single computing system and application. For example, a monolithic application may operate on a computing system to perform the same functions as one or more of the applications executed by the server (151) and the user devices A (180) and B (185) through N (190).

Turning to FIG. 2, the system (200) processes data including video and pictures to update and maintain checklists and corresponding checklist items served to the evaluation device (210) and review device (220) from the server (250). The evaluation device (210) and the review device (220) are user devices, as discussed with FIG. 1, that capture video, pictures, data, etc., corresponding to checklist items maintained by the server (250). The server (250) uses the checklist processor (252) to process the data provided by the evaluation device (210) and the review device (220) and maintain the checklist items of one or more checklists for one or more worksites.

The checklist item (271) is transmitted from the server (250) to the evaluation device (210) and displayed on the evaluation device (210). The checklist item (271) may be transmitted in response to a user logging into the system (200) and requesting to view a checklist for a worksite that includes the checklist item (271).

Responsive to display of the checklist item (271), the evaluation video (273) may be captured with the evaluation camera device (212) and transmitted back to the server (250) by the evaluation device (210). The evaluation video (273) may be transmitted as part of a live stream or as a recorded video file. The evaluation picture (275) may be extracted from the evaluation video (273) and enhanced to include embedded data, contextual data, markup data, etc.

After receiving the evaluation video (273) and the evaluation picture (275), the checklist processor (252) may update the checklist item (271) to the evaluated checklist item (277). The evaluated checklist item (277) may include the evaluation video (273), the evaluation picture (275), and an indication that the checklist item is not complete. The evaluated checklist item (277) may be transmitted to the review device (220), which may display the evaluated checklist item.

After receiving the evaluated checklist item (277), the review device (220) may capture the review video (279) and the review picture (281) with the review camera device (222). The review device (220) may be operated by a supervisor to determine and document the completion of work identified in the evaluation video (273) and the evaluation picture (275). The review video (279) and the review picture (281) are transmitted to the server (250) to be processed by the checklist processor (252).

After receiving the review video (279) and the review picture (281), the checklist processor (252) may update the evaluated checklist item (277) to the reviewed checklist item (283). The reviewed checklist item (283) may include the review video (279) and the review picture (281) as well as the evaluation video (273) and the evaluation picture (275) with an indication that the checklist item has been completed. The reviewed checklist item (283), or a notification message thereof, may be transmitted to the evaluation device (210) and to the review device (220) for review by the users of the evaluation device (210) and the review device (220).

In an embodiment, an issue that is identified may be referred to as a punch item and the device that documents the punch item may be referred to as a punch device. The punch device may operate as one or both of the evaluation device (210) and the review device (220).

Turning to FIG. 2B, the crew device (231) may be operated similar to the evaluation device (210) of FIG. 2A by a member of a crew doing work at a worksite. The crew may perform work at the worksite, e.g., installing a pipe, and document completion of the work by recording the evaluation video A (233). The supervisor device (241) maybe operated similar to the review device (220) of FIG. 2A by a supervisor that reviews the work performed by the crew. In the “happy path”, the work is performed without issue and the evaluation video A (233) and the review video A (243) are recorded without additional videos or pictures.

In an alternative path, the supervisor may find an issue that is documented with the review video A (243) and the review picture A (245). The crew may then go back to perform the work to resolve the issue and the record evaluation video B (237) and the evaluation picture B (239) that document resolution of the issue. The supervisor may then record the review video B (247) and the review picture B (249) that document and confirm resolution of the issue.

In another path, the crew may find an issue that is documented with the evaluation video A (233) and the evaluation picture A (235) that prevents the crew from performing work at the work site. For example, a crew performing plumbing work may be unable to install a pipe after a mistake made by a crew performing concrete work. After the concrete work crew resolves the issue, the crew performing plumbing work may perform their work and document its completion with the evaluation video B (237) and the evaluation picture B (239).

Turning to FIG. 2C, a member of a quality control team may operate the quality control device (251) (e.g., smartphone) that acts as both the evaluation device (210) of FIG. 2A and as the review device (220) of FIG. 2A. The member of a quality control team may identify an issue that is documented with the evaluation video (253) and the evaluation picture (255), perform the work to resolve the issue, and document the resolution by capturing the review video (257) and the review picture (259).

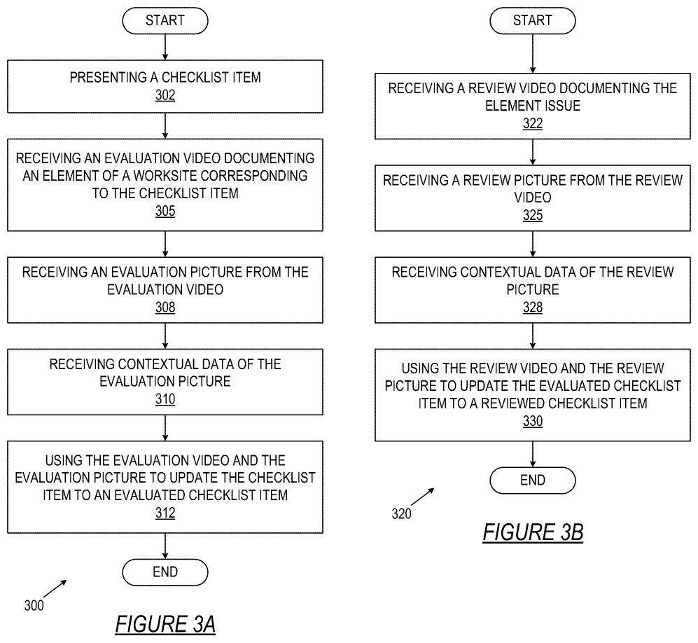

FIG. 3A and FIG. 3B illustrate the processes (300) and (320). In one embodiment, a system may include at least one processor and an application that, when executing on the at least one processor, performs one or more of the processes (300) and (320). In one embodiment, a non-transitory computer readable medium may include instructions that, when executed by one or more processors, perform the processes (300) and (320).

Turning to FIG. 3A, the process (300) implements a method of a video markup system. The process (300) captures evaluation data and includes multiple steps that may execute on the components described in the other figures, including those of FIG. 1 and FIG. 54A.

Step 302 includes presenting a checklist item. Presenting the checklist item may include transmitting the checklist item from a server, receiving the checklist item at an evaluation device, and displaying the checklist item on the evaluation device. The evaluation device may be a mobile device. The checklist item may be displayed as part of a user interface of a user application with multiple interface elements. The interface elements may receive inputs from the user to operate the user application and update data related to the checklist item.

In an embodiment, a selection of the checklist item is received after the checklist item is presented in a user interface. For example, the checklist item may be displayed as part of a checklist for a worksite that includes multiple checklist items.

In an embodiment, a camera view is presented responsive to a selection of the checklist item. The camera view may be displayed on a user device (an evaluation device or a review device) to record the evaluation video or a review video.

In an embodiment, a playback view is presented responsive to a selection of the checklist item. The playback view displays one or more of the evaluation video and a review video.

In an embodiment, embedded information may be presented in a camera view or a playback view with one or more of the evaluation video and a review video. For example, a pipe evaluation device that includes a camera at the end of a plumbing snake may provide embedded information that identifies the distance the camera has traveled into the pipe.

Step 305 includes receiving an evaluation video documenting an element of a worksite corresponding to the checklist item. The evaluation video may be captured with a user device and received by a server after transmission from the user device. As an example, the element of the worksite may be a pipe captured in the evaluation video for a checklist item that involves installation of the pipe at the worksite. Upon receipt, the evaluation video may be stored to a repository.

In an embodiment, the evaluation picture is adjusted to include the markup data, one or more watermarks, and one or more overlays comprising overlay data. For example, a user device may receive an image from a camera and incorporate the markup data, watermarks, overlays, etc., into the color values for the pixels of the image to generate the evaluation picture.

Step 308 includes receiving an evaluation picture from the evaluation video. The evaluation picture documents an element issue portrayed in the evaluation video. The evaluation picture may be captured by the user device and transmitted to the server. In an embodiment, the evaluation picture is extracted from the evaluation video. The evaluation picture and the evaluation video may include additional information, watermarks, address information, contextual information, etc. The element issue portrays an issue with the element depicted in the evaluation picture related to the checklist item. For example, the element issue may be a clog in a pipe.

Step 310 includes receiving contextual data of the evaluation picture. The contextual data may be received by capturing inputs from the user at the user device forming the contextual data, transmitting the contextual data from the user device, and receiving the contextual data at the server. The contextual data of the evaluation picture may include markup data of the evaluation picture. For example, the markup data may include a circle drawn around the clog portrayed in the evaluation picture.

Step 312 includes using the evaluation video and the evaluation picture to update the checklist item to an evaluated checklist item. The checklist item may be updated by including an evaluation video thumbnail of the evaluation video and an evaluation picture thumbnail of the evaluation picture in the display of the checklist item. Additionally, a status of the checklist item may be updated. For example, the status may be updated to “incomplete” to indicate that additional work is required at the worksite for the element corresponding to the checklist item.

Turning to FIG. 3B, the process (320) implements a method of a video markup system. The process (320) captures review data and includes multiple steps that may execute on the components described in the other figures, including those of FIG. 1 and FIG. 54A.

Step 322 includes receiving a review video documenting the element issue. The review video may be captured with a review device, transmitted from the review device, and received by the server. The review device may be different from the evaluation device. The review video may be captured and then received after the checklist item with the evaluation video is displayed on the review device.

In an embodiment, a verification view is presented using the evaluation video and the evaluation picture with an interface element to initiate recording the review video. The verification view may be presented on a review device prior to transmitting the review video to the server.

Step 325 includes receiving a review picture from the review video. The review picture may be captured by the review device by extracting the review picture from the review video. After generating the review picture, the review picture may be transmitted to the server. The review picture documents resolution of the element issue portrayed in the evaluation video. For example, the review picture may show the location in a pipe where a clog was identified in the evaluation picture but is not present in the review picture.

Step 328 includes receiving contextual data of the review picture. The contextual data may be received by the review device in response to interaction with the interface elements of the user interface presented by the review device to the user. The contextual data of the review picture may include markup data of the review picture. The markup data of the review picture may contrast with the markup data of the evaluation picture. For example, the evaluation picture may have included a circle using a first color (e.g., red) that identified the clog in the pipe and the review picture may include a circle in a different color (e.g., green) that identifies the location of the pipe where the clog is no longer found.

Step 330 includes updating the evaluated checklist item to a reviewed checklist item using the review video and the review picture. The evaluated checklist item may be updated by including a review video thumbnail of the review video and a review picture thumbnail of the review picture in the display of the evaluated checklist item. Additionally, a status of the checklist item may be updated. For example, the status may be updated to “complete” to indicate that the additional work to address the element issue as well as the checklist item and related tasks are completed or have been verified.

In an embodiment, a verification view may be presented using the evaluation video, the evaluation picture, a review video, and a review picture. For example, a verification view may display the evaluation video side by side with the review video. The verification view may also display the evaluation picture side by side with the review picture.

In an embodiment, the update to the status may be performed automatically using a large language model. The evaluation picture and the review picture may be input to the large language model with a prompt directing the large language model to identify whether the element issue identified in the evaluation picture remains present in the review picture. The output of the large language model may then trigger the system to change the status of the checklist item to complete when the output of the large language model indicates that the element issue is no longer present.

In an embodiment, presenting a verification view using the evaluation picture and a review picture with embedded data overlaid onto a thumbnail of the evaluation picture and a thumbnail of the review picture. For example, the embedded data overlaid onto the thumbnails may identify the distance the camera is extended into a pipe when the image is taken with the camera of a pipe inspection device.

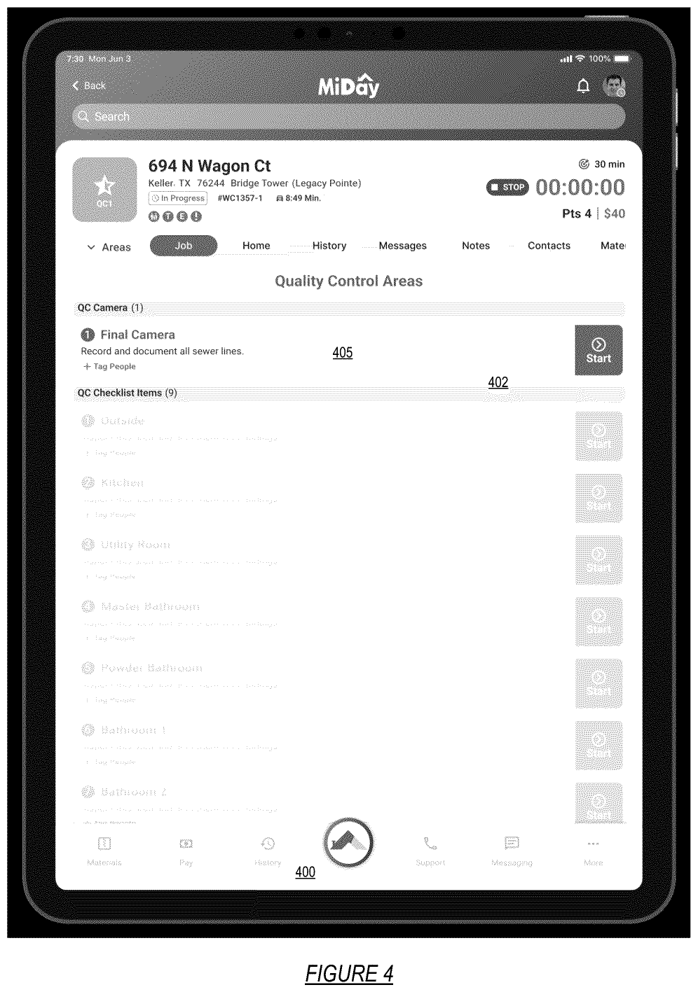

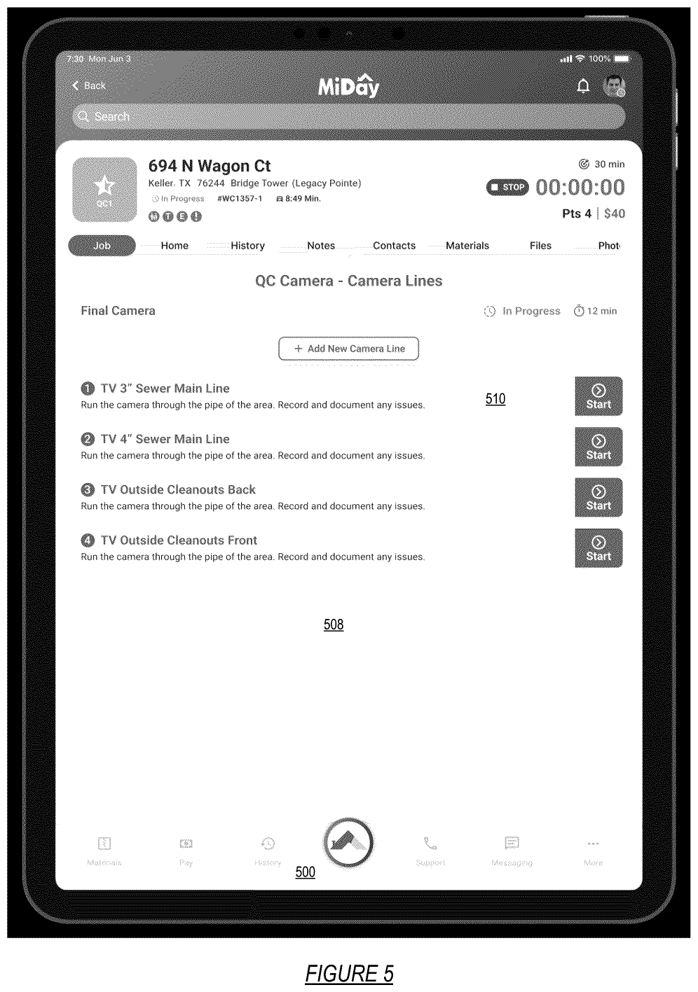

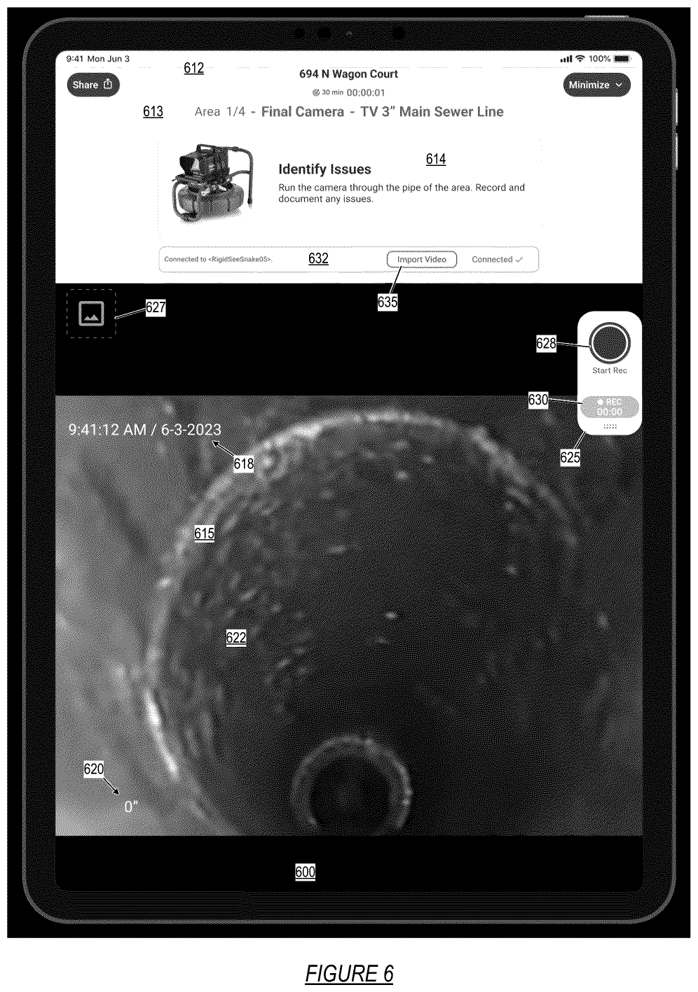

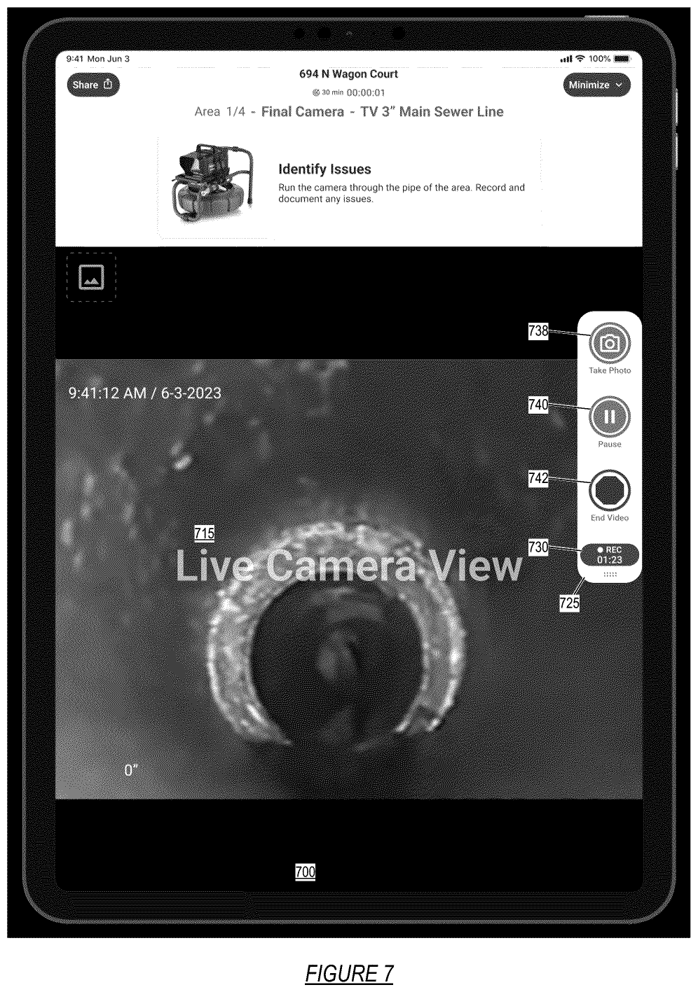

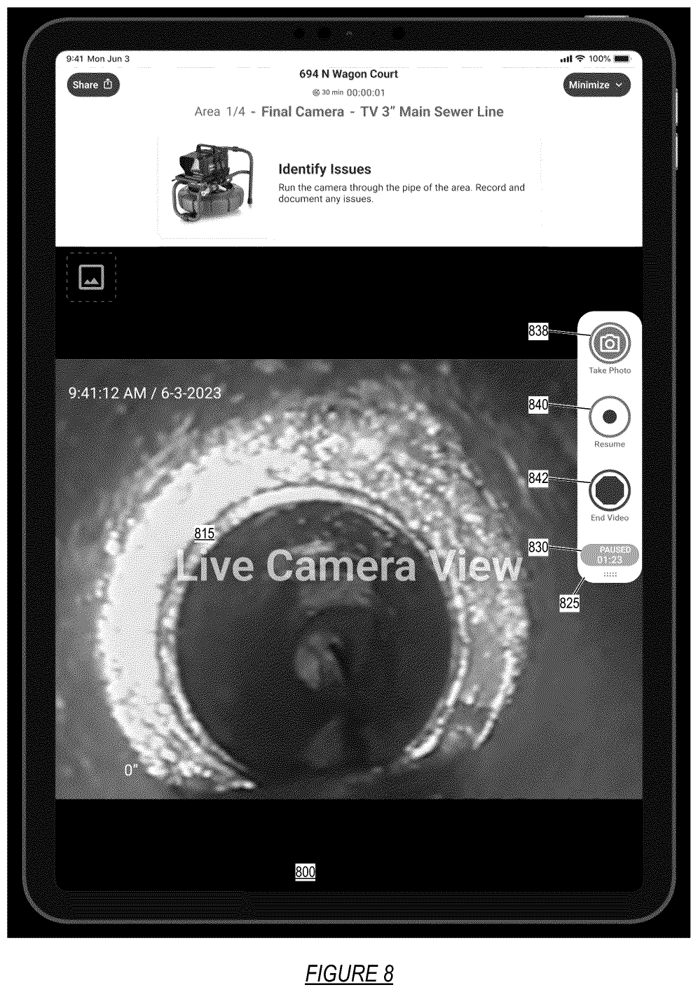

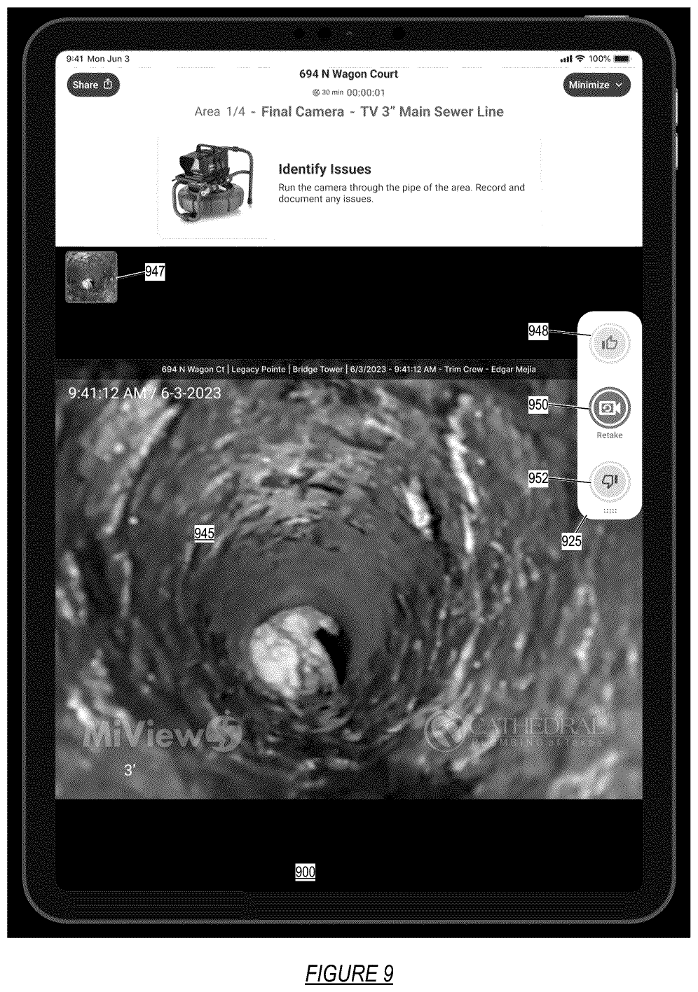

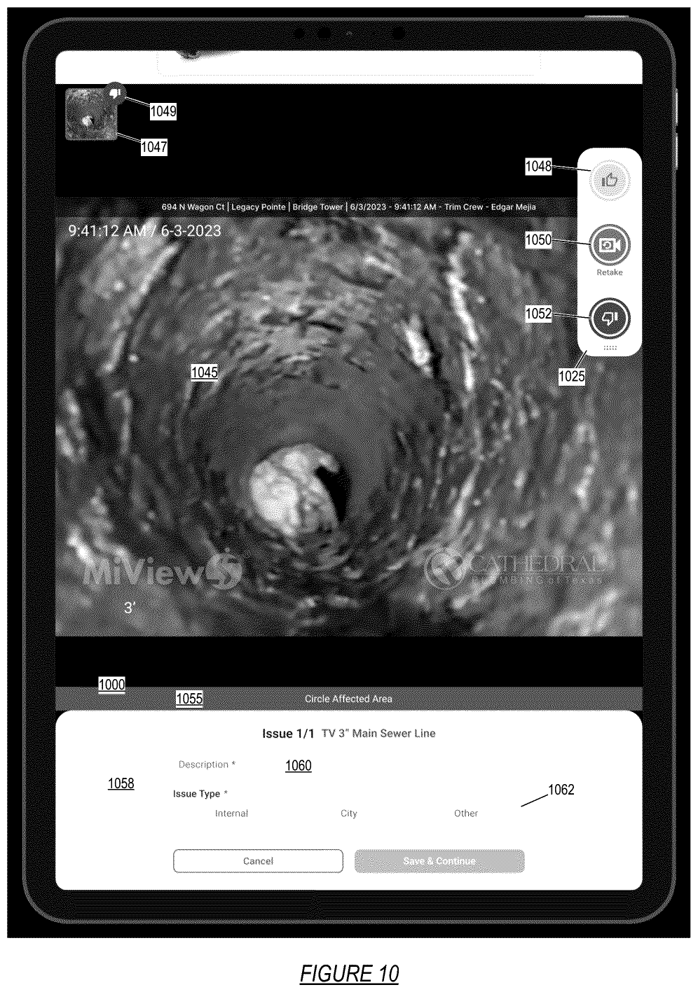

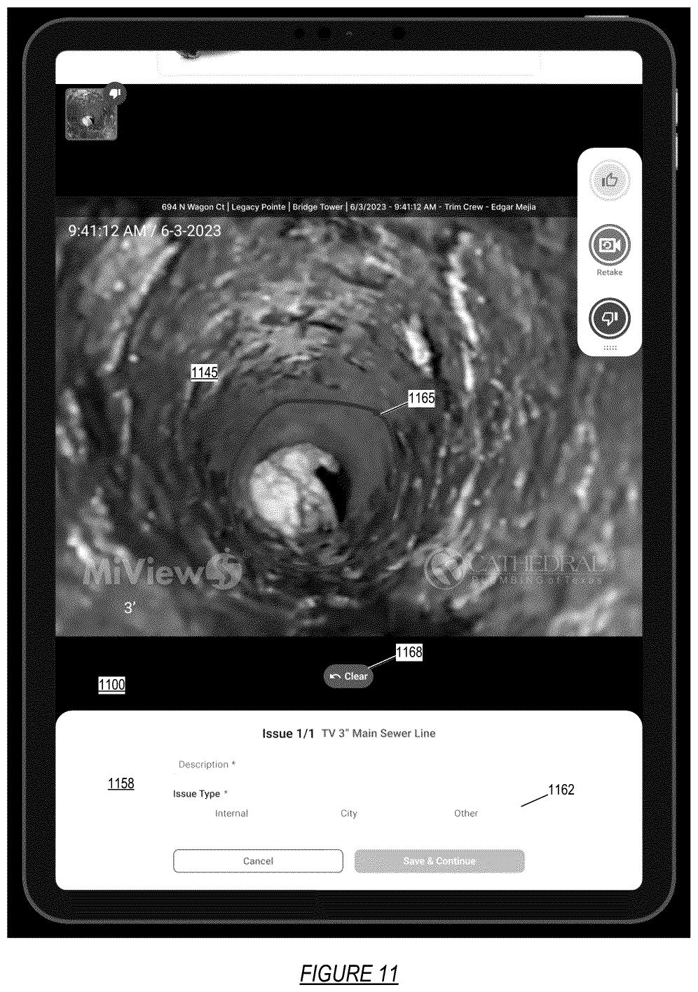

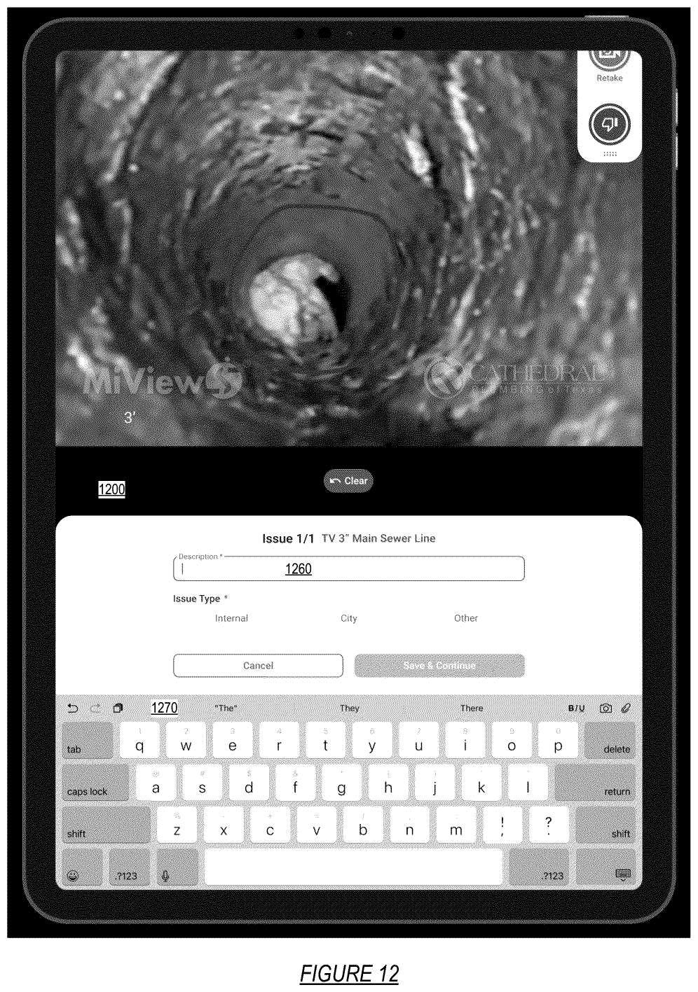

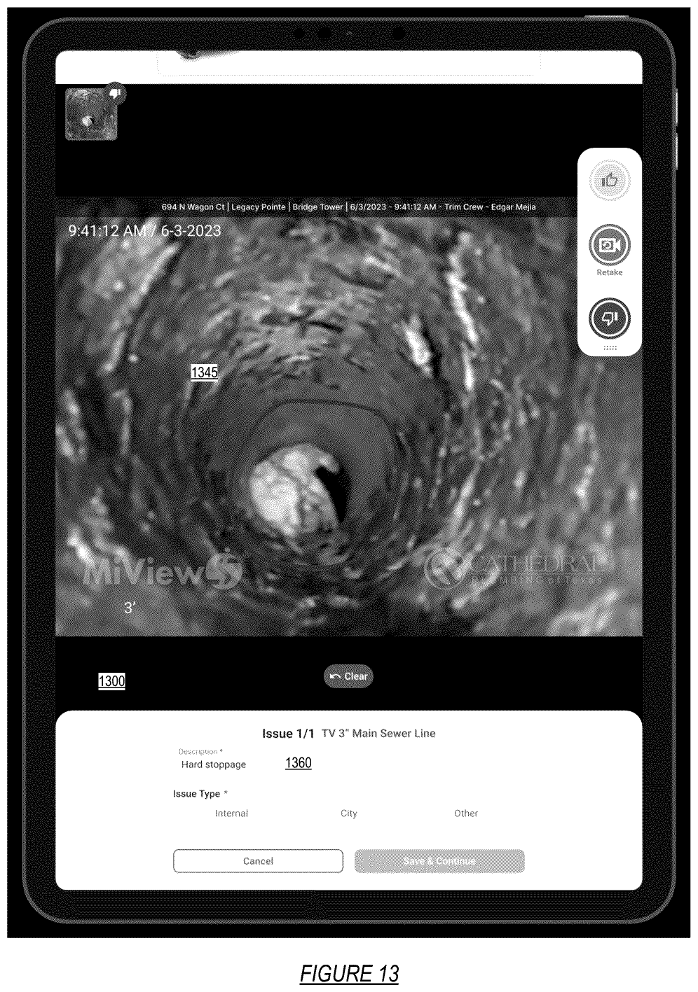

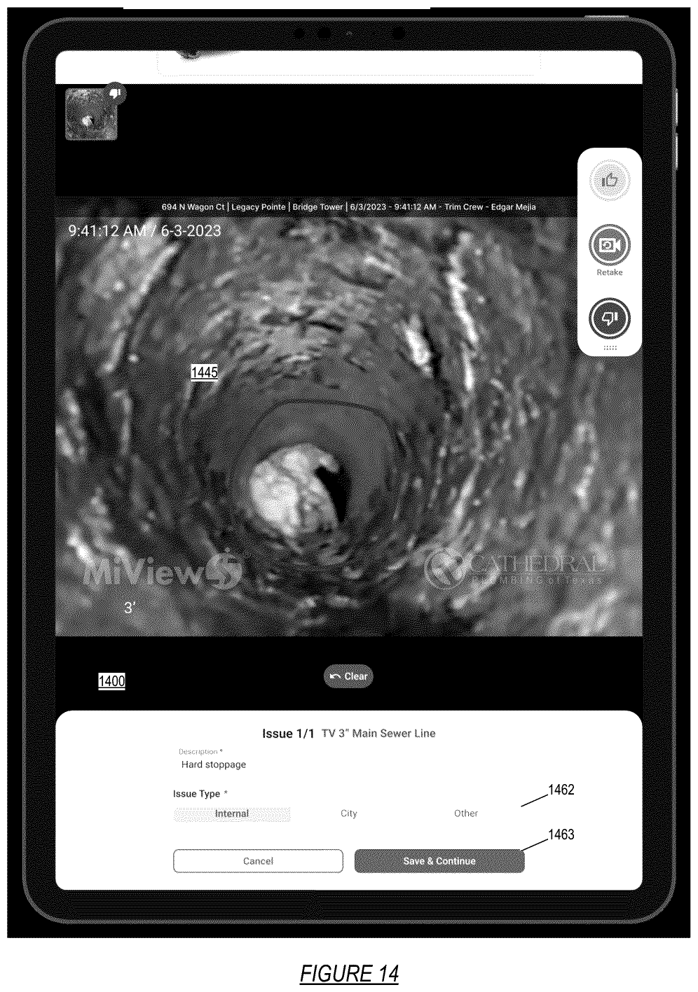

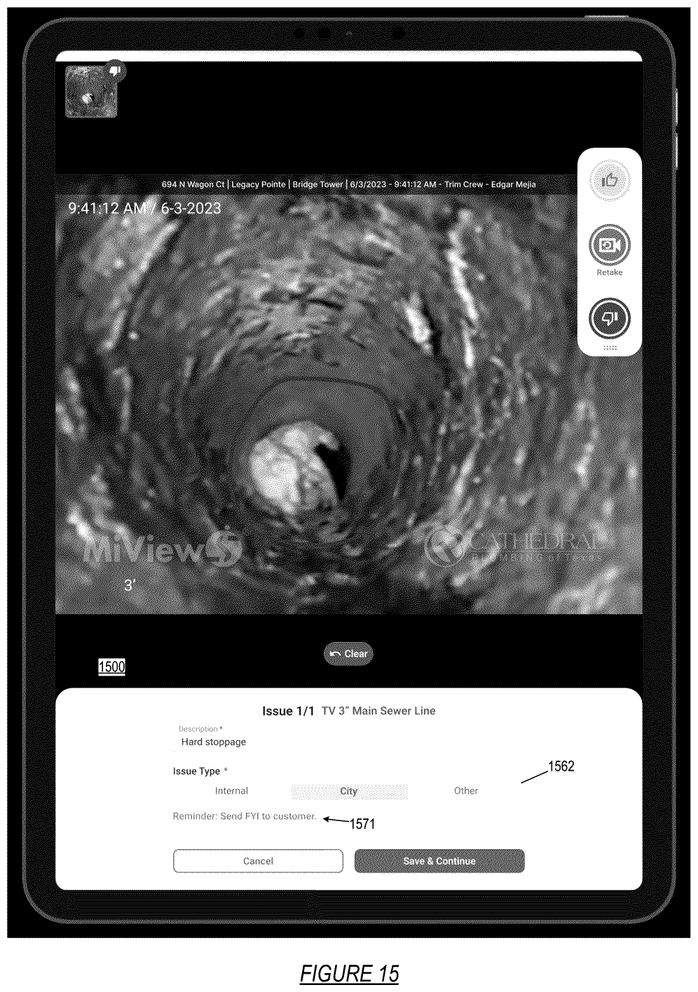

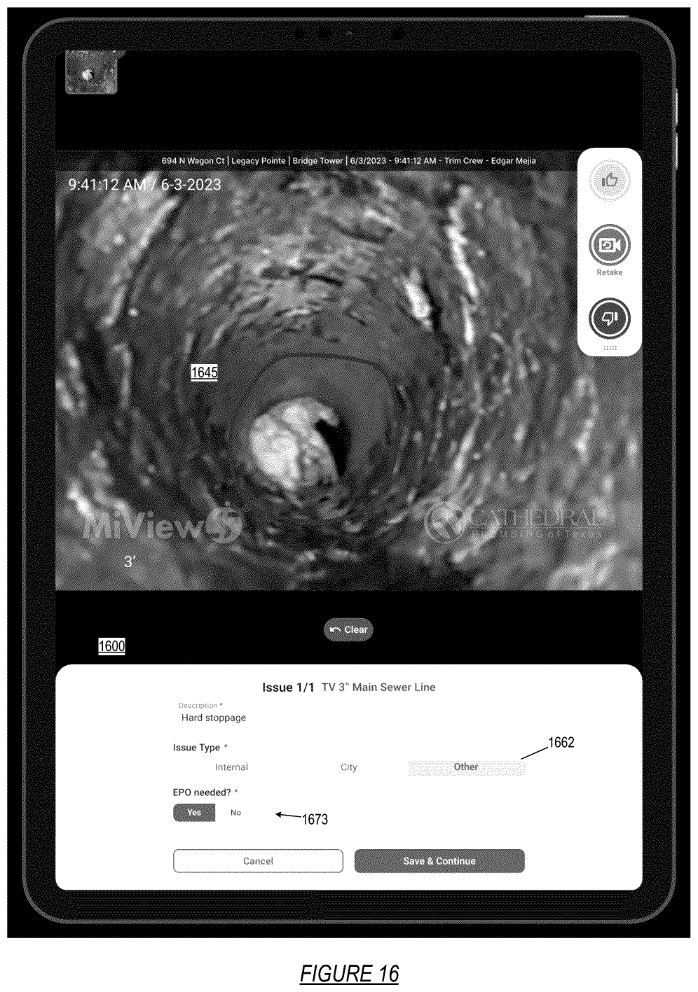

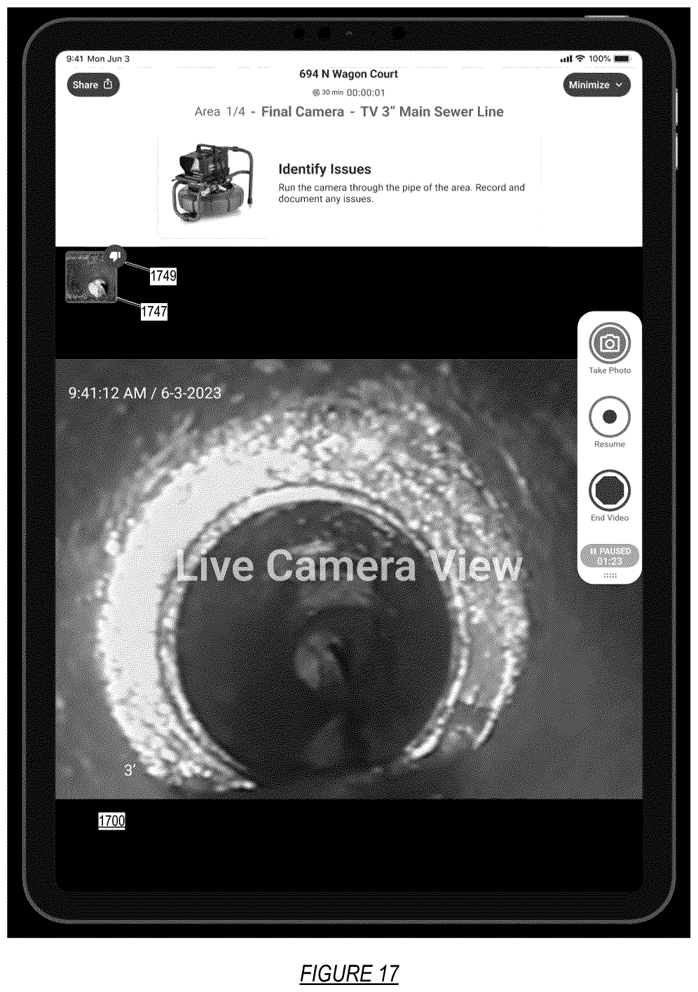

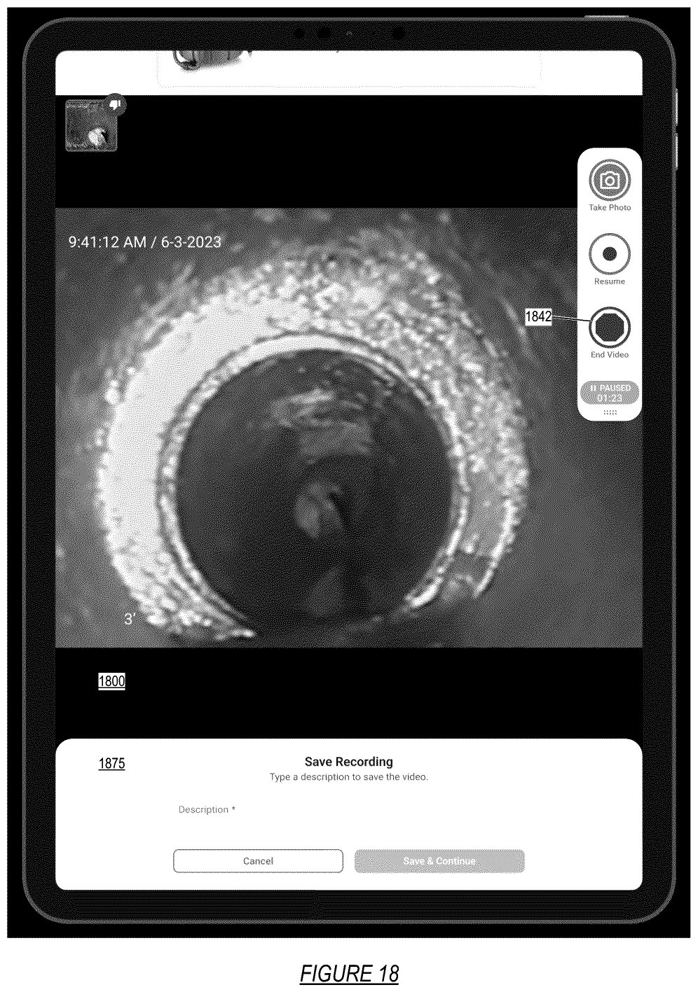

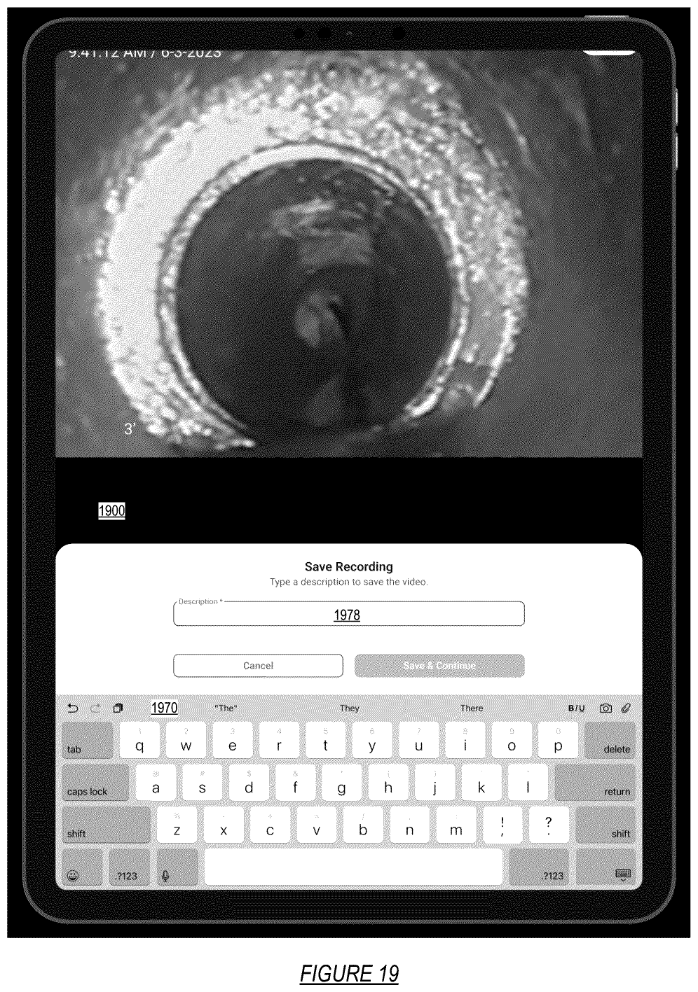

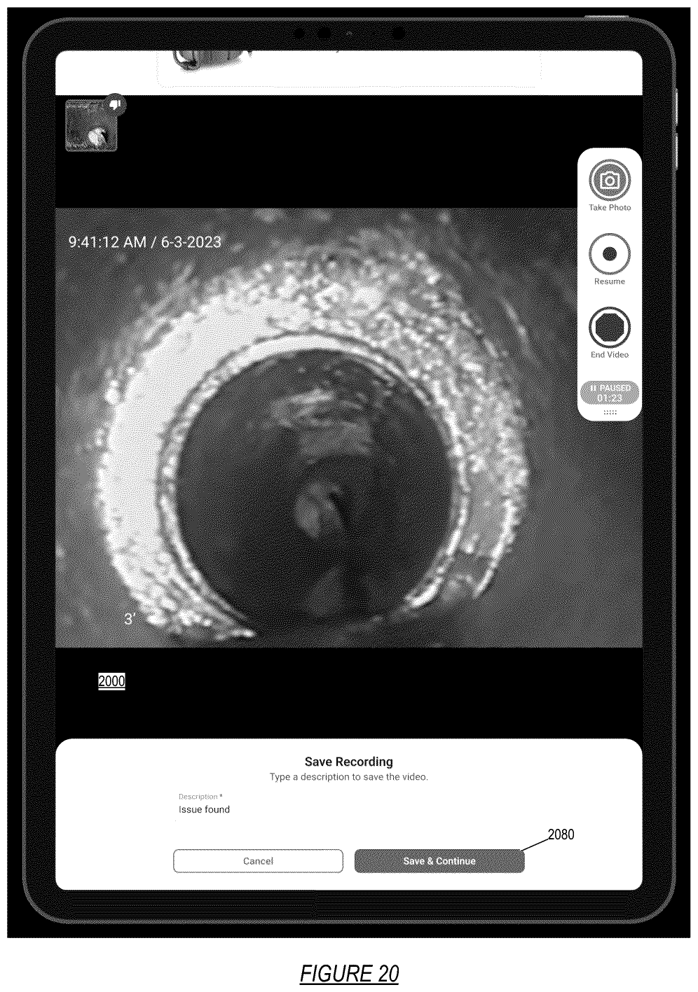

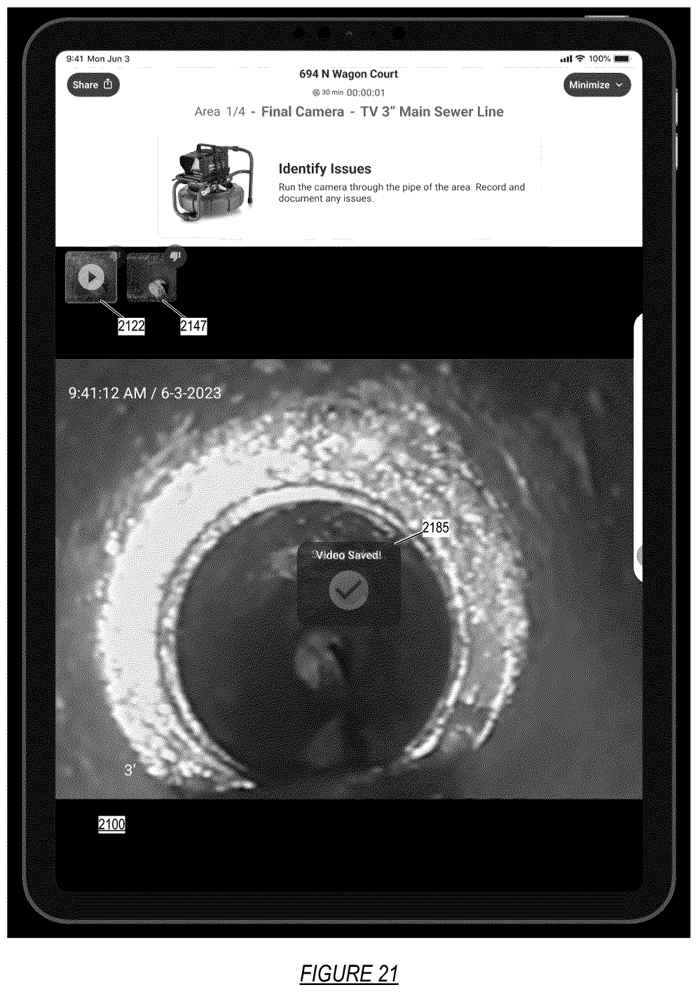

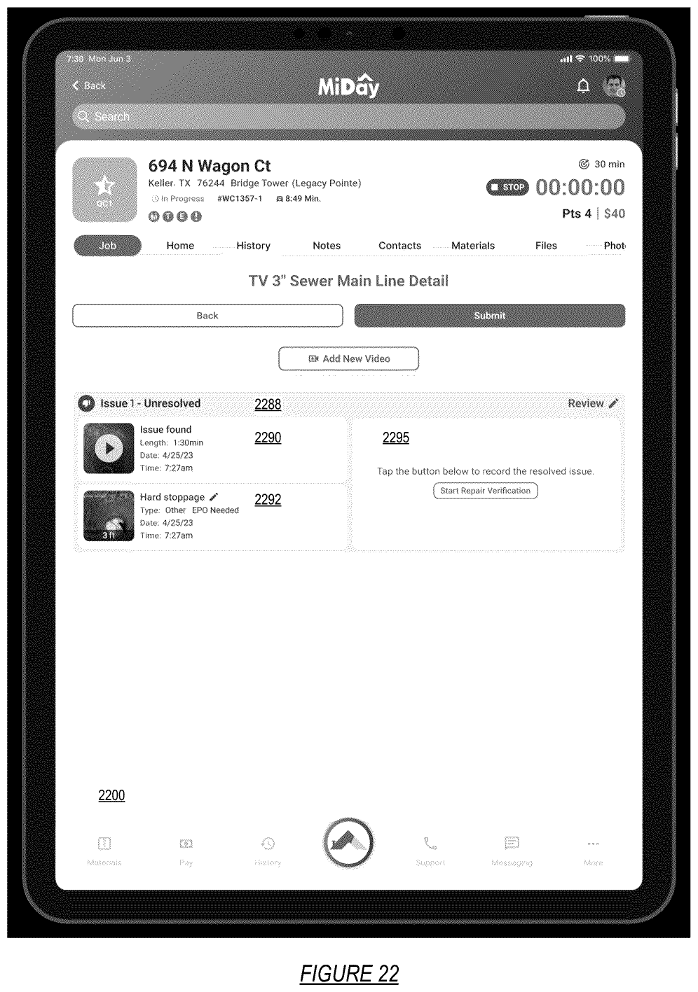

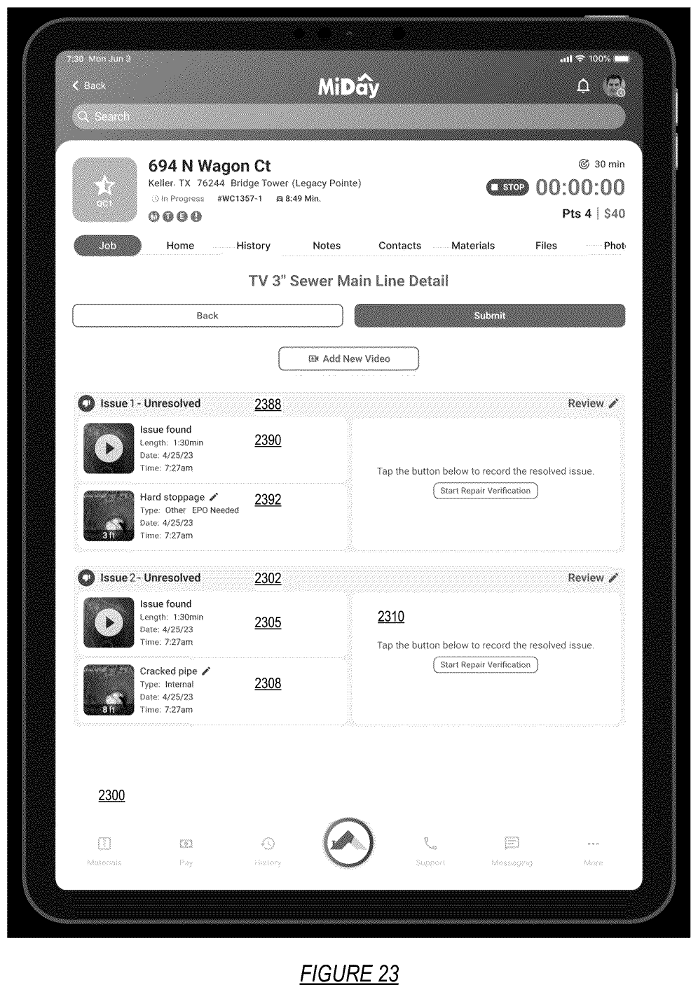

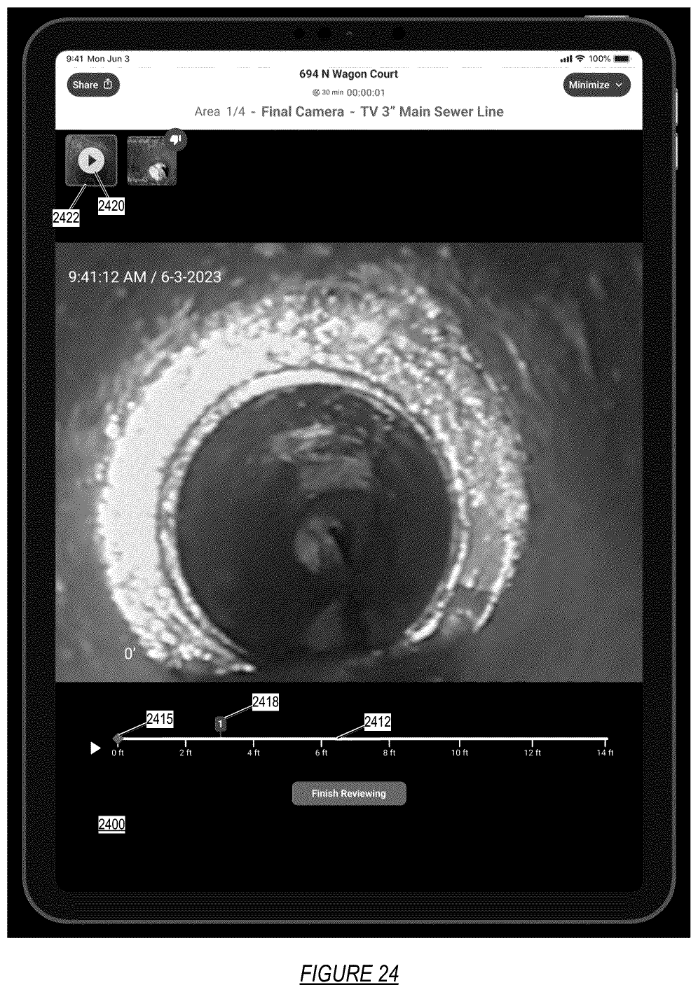

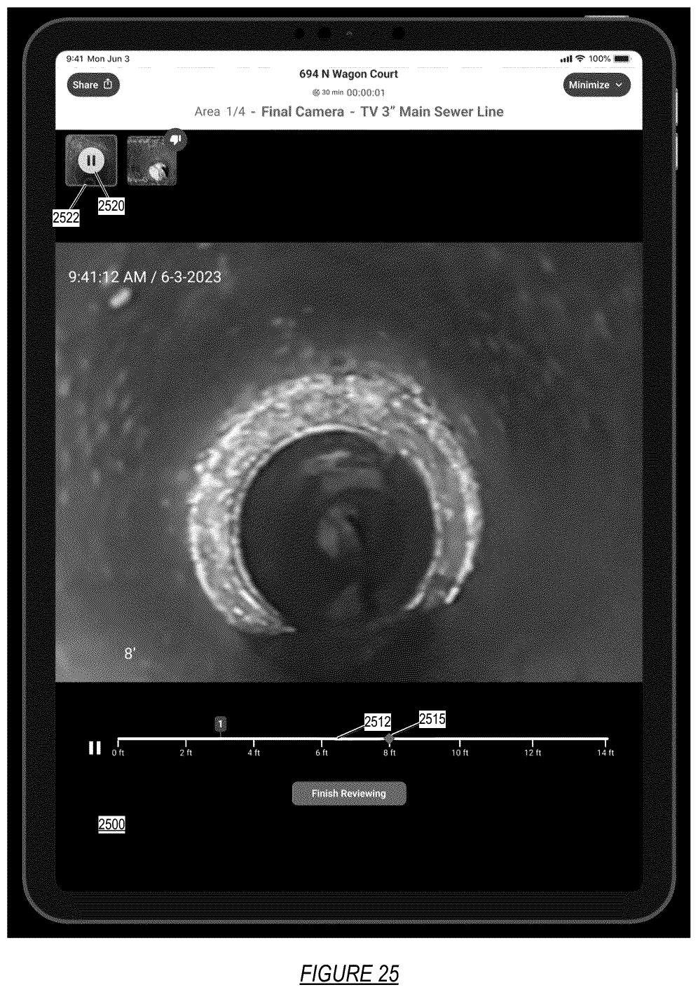

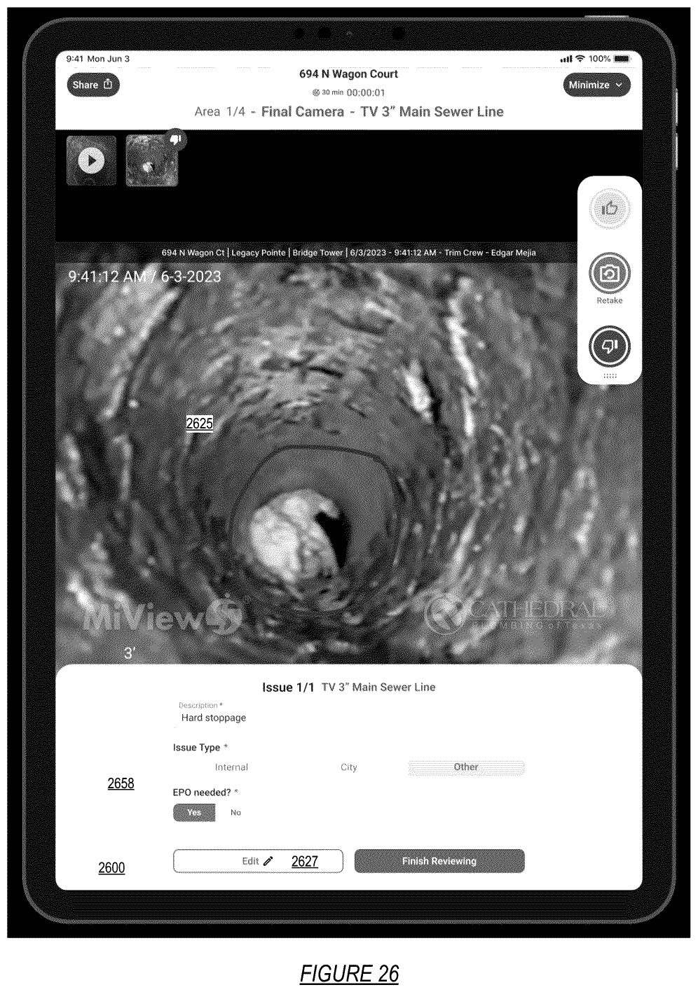

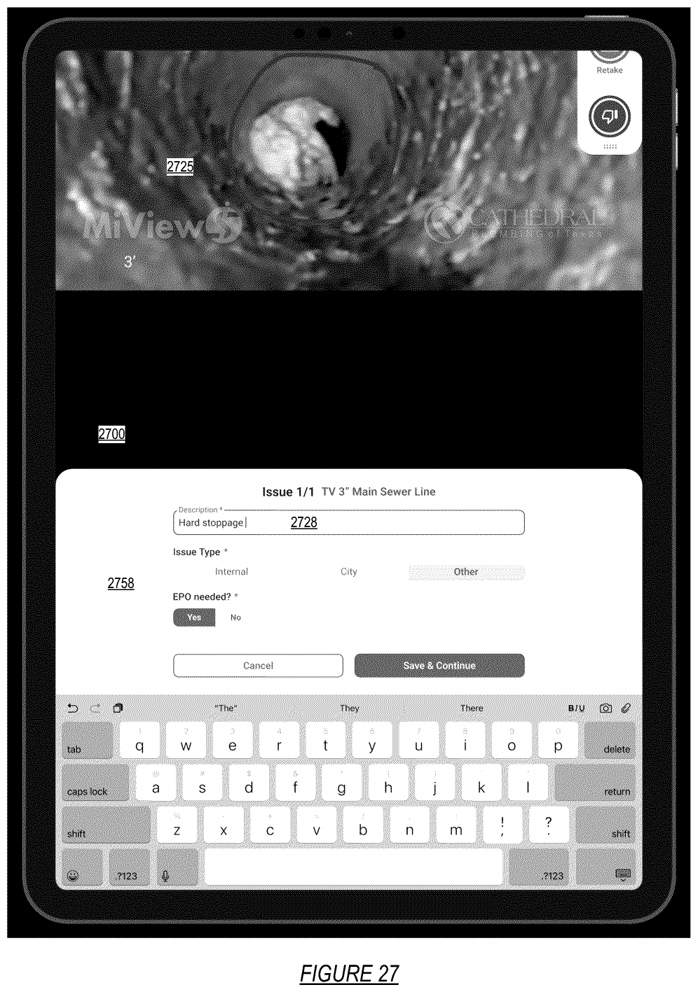

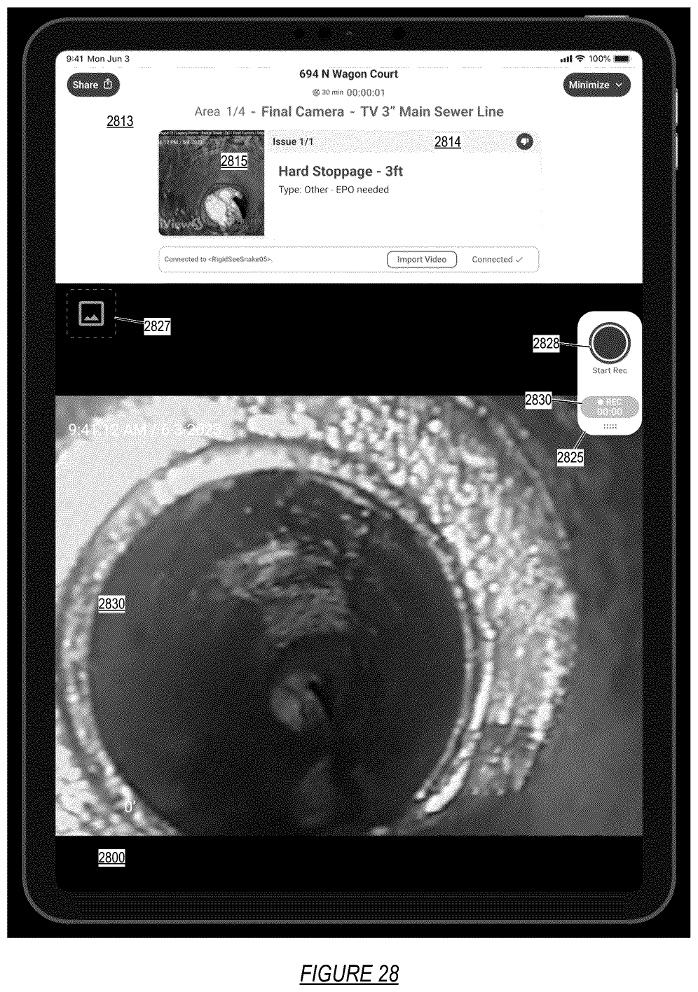

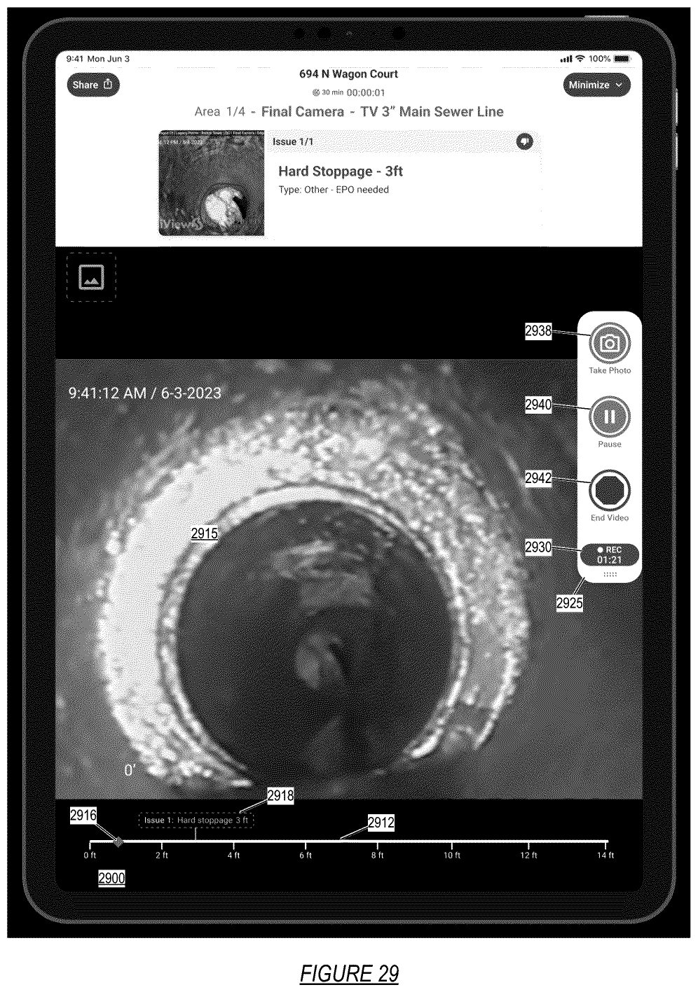

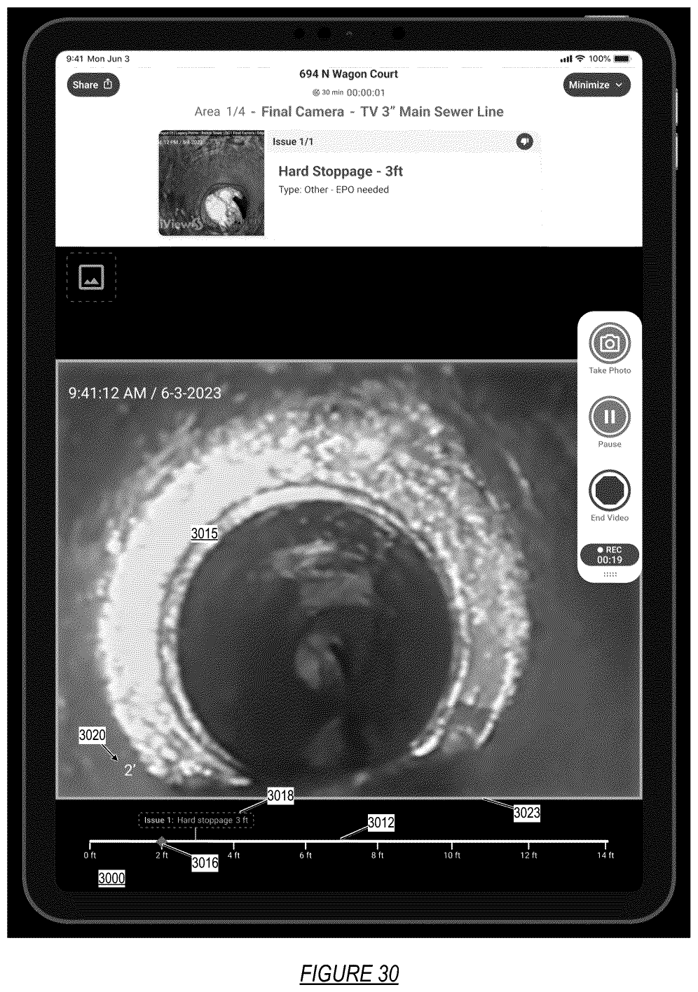

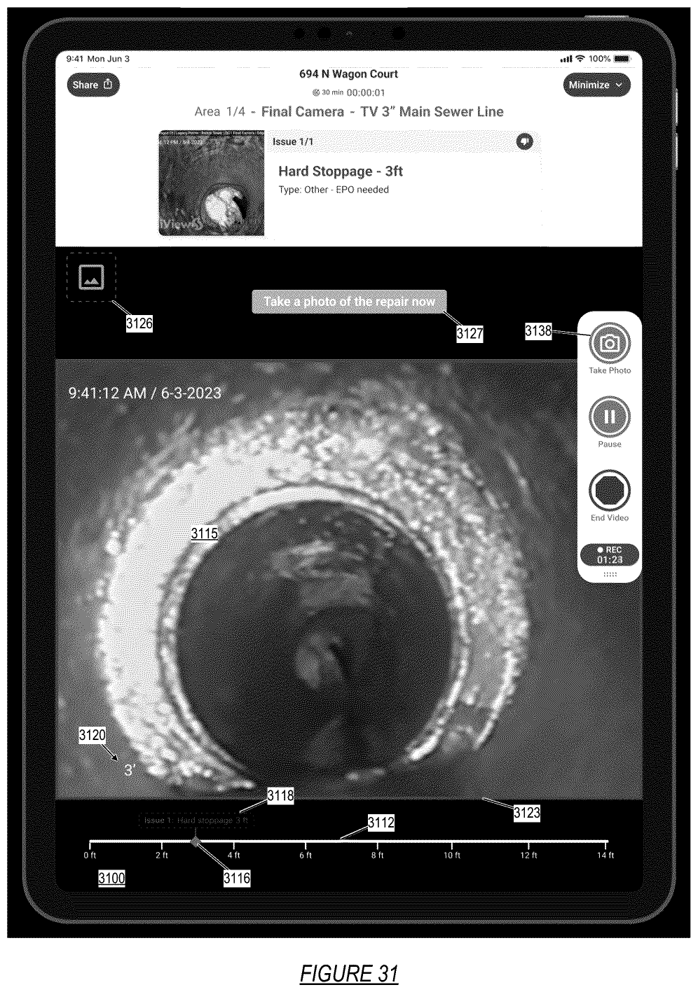

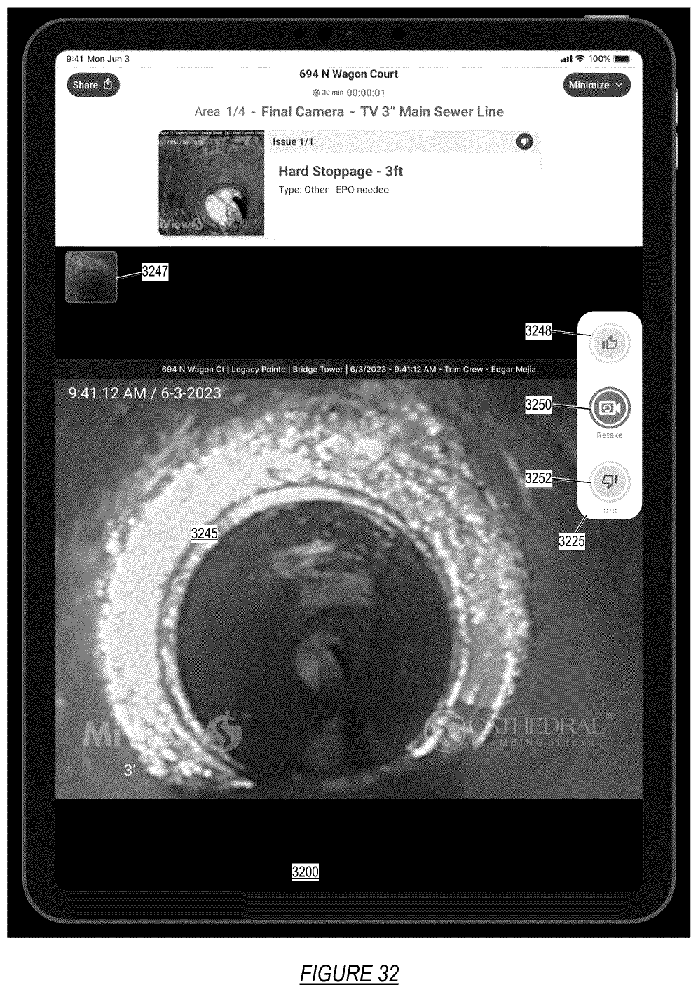

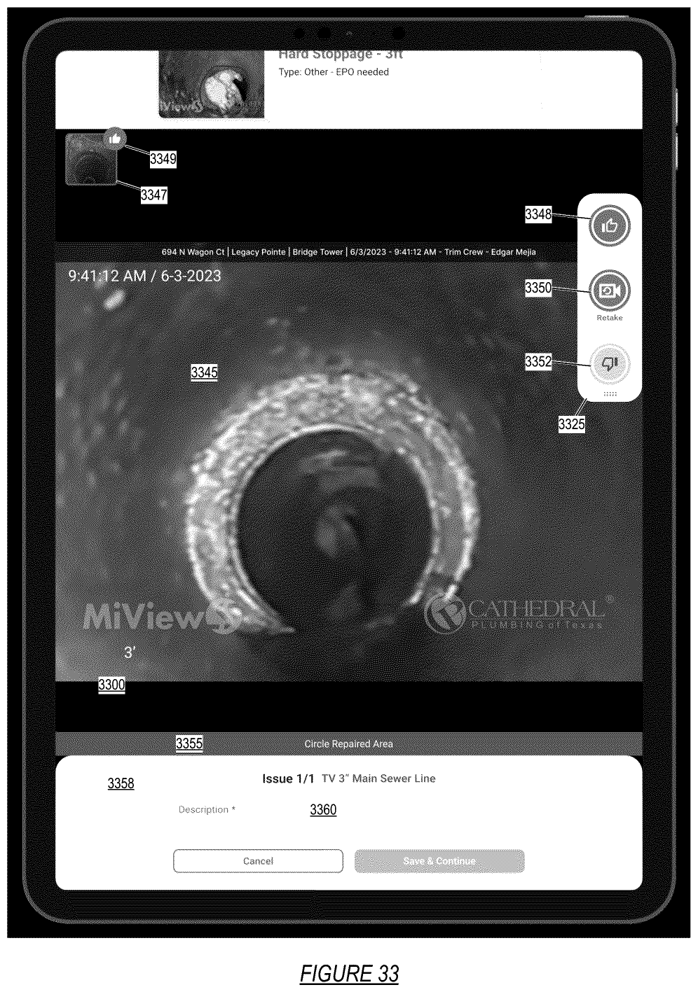

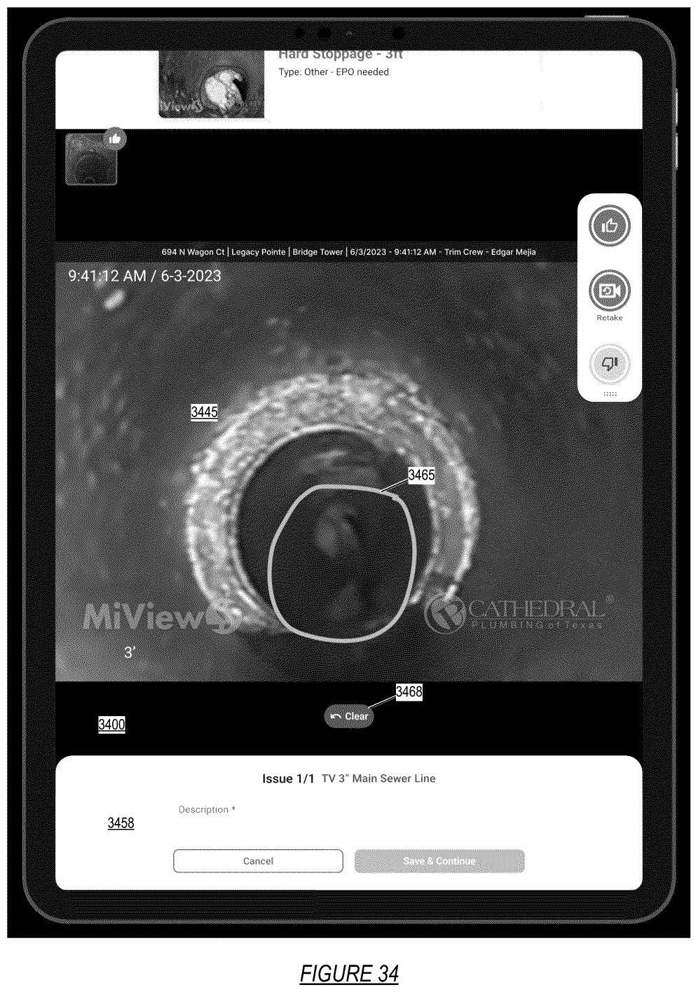

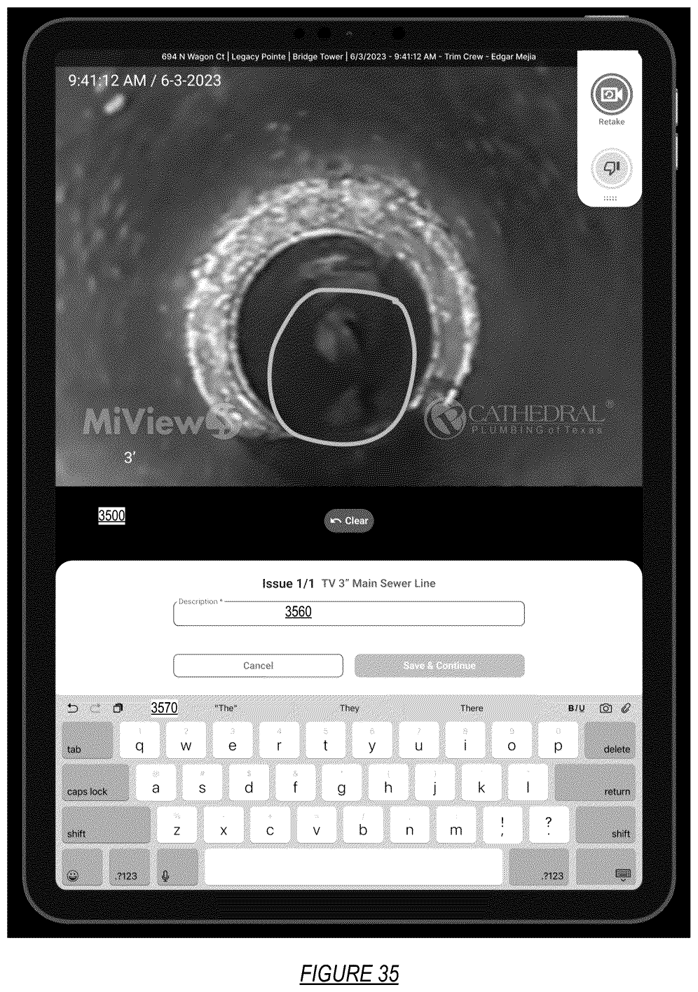

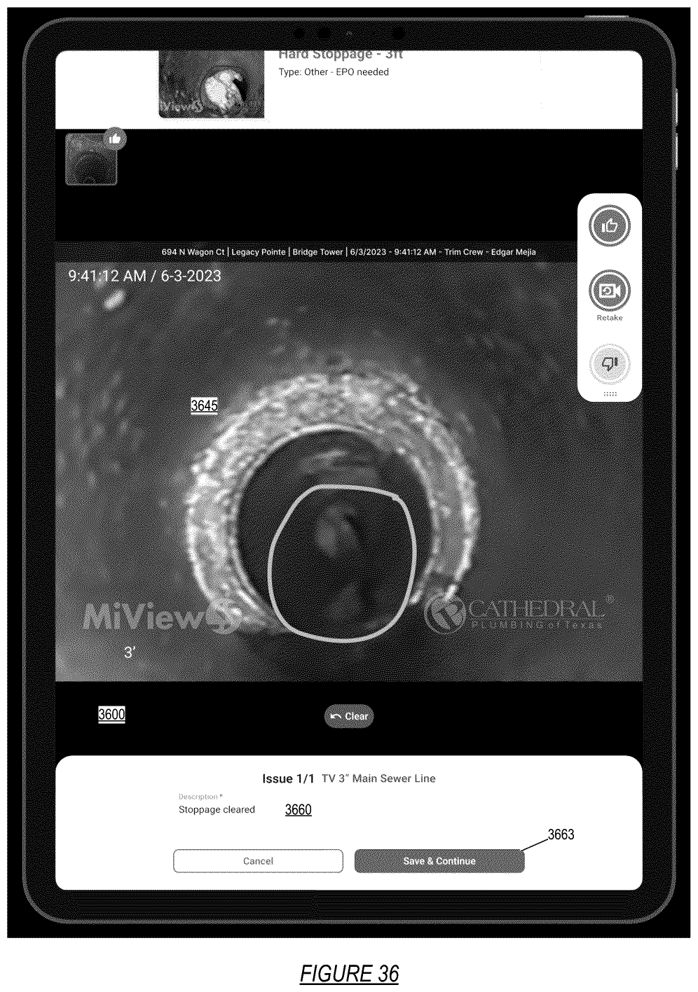

Turning to FIG. 4, the user interface (400) displays the checklist (402). The user interface (400) also displays worksite information that identifies the physical address of the worksite. The checklist (402) includes several checklist items that identify locations at the worksite along with tasks to perform at the locations. The checklist (402) includes the checklist item (405) titled “Final Camera”. The checklist item (405) may be selected with the interface element displayed as a button labeled “Start”.

Turning to FIG. 5, the user interface (500) is displayed in response to selection of the checklist item (405) from FIG. 4. The user interface (500) displays another checklist, referred to as the camera checklist (508). The camera checklist (508) includes multiple checklist items. Each of the checklist items for the camera checklist (508) correspond to tasks that require capturing video of work performed at the worksite. The user device displaying the user interface (500) is operating as an evaluation device to capture evaluation videos and evaluation pictures. The checklist (508) includes the checklist item (510). The checklist item (510) includes a numeric identifier, a title, a description, and an interface element. The checklist item (510) may be selected with the interface element displayed as the button labeled “Start” to start the process of recording an evaluation video.

Turning to FIG. 6, the user interface (600) is displayed in response to selection of the checklist item (510) from FIG. 5. The user interface (600) displays the record video page (612) that includes the item view (613) and the camera view (615).

The item view (613) provides information about the checklist item (510) of FIG. 5 that was selected. The item view (613) displays the physical address of the worksite (“694 N Wagon Court”) and the name of the checklist item (510) (“TV 3″ Main Sewer Line”). The item view (613) includes the interface element (614).

The interface element (614) includes an image and text to prompt the user of the device to take action to complete the checklist item (510) of FIG. 5. The image displays an image of the pipe inspection device that is presently connected to the user device. The text instructs the user to “Run the camera through the pipe of the area. Record and document any issues.”

When a camera device is connected (as illustrated in FIG. 6), embedded information may be displayed within the camera view (615). The embedded information in the camera view (615) may include the timestamp (618) with time and date overlaid onto the video in a top left corner. A timestamp (618) may indicate when the camera was started. The embedded information in the camera view (615) may also include additional implementation-specific information. The implementation-specific information displayed in the camera view (615) may include the distance information (620). The distance information (620) identifies the distance traveled by the camera into the pipe (622) displayed in the camera view (615).

The user interface (600) further includes the interface element (625) with the button (628) labeled “Start Rec” for starting the recording of an evaluation video. The interface element (625) also includes the status element (630) to identify the recording status, which is currently not recording as indicated by the status element (630) being presented with a grey color to be “greyed out”. The interface element (625) may be moved to a different location on the user interface (600) by dragging the Interface element (625) from one location to another.

The user interface (600) further includes the interface element (632) with the button (635) labeled “Import Video”. Selection of the button (635) may bring up additional user interface elements to select a video that has already been recorded to be imported and used as the evaluation video for the checklist item. The interface element (632) includes additional text (“Connected”) to indicate that the application running the user interface (600) is connected to a camera device and includes an identifier (“RigidSeeSnakeOS”) for the camera device that is connected.

In an embodiment (not shown), when a camera device is not connected, the camera view (615) may be blank. The interface element (632) may still include the button (635) to import a video. The interface element (632) may also replace the additional text with a connection button that, when selected, allows the user to connect the device operating the user interface (600) to a camera to record an evaluation video.

The user interface (600) also displays the empty thumbnail icon (627). The empty thumbnail icon (627) is a placeholder that identifies the location that a thumbnail will be placed for an image captured with the device.

Turning to FIG. 7, the user interface (700) is displayed after selection of the button (628) from FIG. 6. The interface element (725) is updated from the interface element (625) of FIG. 6. The interface element (725) includes the buttons (738), (740), and (742) with the status element (730). Selection of the button (738) labeled “Take Photo” captures an image from a live view of the camera displayed in the camera view (715). Selection of the button (740) labeled “Pause” pauses the recording of the evaluation video. Selection of the button (742) labeled “End Video” stops the recording of the evaluation video. The status element (730) is colored red to indicate that recording is in progress and includes a time value to identify the duration of the current recording for the evaluation video.

The interface element (725) may be moved around the user interface (700) to avoid obscuring portions of the user interface (700). For example, a user may touch and hold a portion of the interface element (725) and then drag the interface element (725) to a different location.

In an embodiment, the user interface (700) may be responsive to audible commands. For example, the user may say “take photo”, “pause”, or “end video” to select the buttons (738), (740), and (742) without touching the buttons (738), (740), and (742).

Turning to FIG. 8, the user interface (800) is displayed after selection of the button (740) from FIG. 7. The interface element (825) is updated from the interface element (725) of FIG. 7. The interface element (825) includes the buttons (838), (840), and (842) with the status element (830). Selection of the button (838) labeled “Take Photo” captures an image from a live view of the camera displayed in the camera view (815). Selection of the button (840) labeled “Resume” resumes recording of the evaluation video. Selection of the button (842) labeled “End Video” stops the recording of the evaluation video. The status element (830) includes status text and is colored orange to indicate that recording is paused and includes a time value to identify the duration of the current recording for the evaluation video.

In an embodiment, the user interface (800) may be responsive to audible commands. For example, the user may say “take photo”, “resume”, or “end video” to select the buttons (838), (840), and (842) without touching the buttons (838), (840), and (842).

Turning to FIG. 9, the user interface (900) is displayed after selection of the button (838) from FIG. 8 or after selection of the button (738) from FIG. 7. The user interface (900) is updated to display the evaluation picture (945). The interface element (925) is updated to include the buttons (948), (950), and (952). Selection of the button (948) with a green-colored thumbs up icon indicates that the evaluation picture (945) does not include any issues. Selection of the button (950) labeled “Retake” discards the current picture so that another picture may be captured. Selection of the button (952) with a red-colored thumbs down icon indicates that the evaluation picture (945) includes an issue with the element being inspected.

In an embodiment, the user interface (900) may be responsive to audible commands. For example, the user may say “thumbs up”, “retake photo”, or “thumbs down” to select the buttons (948), (950), and (952) without touching the buttons (948), (950), and (952).

The evaluation picture (945) is extracted from the video (either imported or live). The evaluation picture (945) includes overlay data and watermarks. The overlay data is placed at the top of the evaluation picture and includes information about the worksite, which includes the physical address, the name of the community where the worksite is located, the name of the builder for the community, a timestamp, and identifier for the crew that performed the work being inspected, and an identifier for the person operating the user device. The watermarks are placed at the bottom left and bottom right corners of the evaluation picture and may identify the vendor of the application, the builder, the organization performing the work, etc.

The user interface (900) is also updated to display the evaluation thumbnail (947). Display of the evaluation thumbnail (947) replaces the display of the empty thumbnail icon (627) of FIG. 6. The evaluation thumbnail (947) is a reduced resolution version of the evaluation picture (945). Multiple thumbnails may be provided when multiple evaluation pictures are captured using the system.

Turning to FIG. 10, the user interface (1000) is displayed after selection of the button (952) from FIG. 9. The user interface (1000) is updated to shift the evaluation picture (1045), display the interface elements (1055) and (1058), and update the button (1052).

The color of the button (1052) from the light red of the button (952) of FIG. 9 to a darker shade of red to indicate that an issue has been identified and is portrayed in the evaluation picture (1045). Additionally, the evaluation thumbnail (1047) is updated from the evaluation thumbnail (947) of FIG. 9 to include the thumbs down icon (1049) displayed in red on the top right corner of the evaluation thumbnail (1047).

The interface element (1055) is a notification bar with the prompt “Circle Affected Area”. The prompt directs the user to mark up the evaluation picture (1045) with a circle around the area in the picture that portrays the issue identified at the worksite.

The interface element (1058) is a dialog box with several interface elements for collecting information from the user. The interface element (1058) includes the interface element (1060) to receive a textual description of the issue portrayed in the evaluation picture (1045).

The interface element (1058) further includes the interface element (1062) to select an identifier for the type of the issue, which may be referred to as the issue type. The type of the issue may be identified as “Internal”, “City”, and “Other”. Other embodiments of the system may use different type identifiers.

Turning to FIG. 11, the user interface (1100) is displayed after the user marks up the evaluation picture (1145). The user interface (1100) is updated to display the markup (1165) and the button (1168).

The markup (1165) may also be referred to as a highlight. The markup (1165) is a red hand-drawn circle around a portion of the evaluation picture (1145). The markup (1165) identifies the location of the issue portrayed within the evaluation picture (1145). Different colors may be used.

The button (1168) is displayed responsive to display of the markup (1165) and in place of the interface element (1055) from FIG. 10. The button (1168) is displayed after the device receives markup data. Selection of the button (1168) may remove the markup (1165), remove display of the button (1168), and trigger the interface element (1055) from FIG. 10 to be redisplayed.

Turning to FIG. 12, the user interface (1200) is updated from the user interface (1100) of FIG. 11. The user interface (1200) is updated to display the keyboard element (1270). The user may operate the keyboard element (1270) to input text to the interface element (1260). In an embodiment, the user may select the microphone button on the keyboard element (1270) to convert speech to text to fill in the interface element (1260).

Turning to FIG. 13, the user interface (1300) is updated from the user interface (1200) of FIG. 12. The user interface (1200) is updated to remove display of the keyboard element (1270) of FIG. 12 and to update the interface element (1360). The interface element (1360) is updated to include text to describe the issue portrayed in the evaluation picture (1345). The text “Hard stoppage” indicates that there is a clog in the pipe being viewed resulting in a hard stoppage of contents through the pipe. Other types of issues may be identified.

Turning to FIG. 14, the user interface (1400) is updated from the user interface (1300) of FIG. 13. The user interface (1400) is updated to show selection of the “Internal” label with the interface element (1462). The interface element (1462) is updated responsive to a user selection to indicate the issue portrayed in the evaluation picture (1445) is an issue with a type identified as “Internal” and not “City” or “Other”. The “Internal” type may indicate that the organization that may have caused the issue documented in the evaluation picture (1445) is the organization that is to resolve the issue. For example, the identification of “Internal” may indicate that the company that installed the pipe caused the issue and will resolve the issue. After a selection is received for the interface element (1462), the button (1463) is enabled. Selection of the button (1463) saves the evaluation picture (1445) with the markup and contextual data provided by the user to the system.

Turning to FIG. 15, the user interface (1500) is updated from the user interface (1300) of FIG. 13. The user interface (1500) is updated to show selection of the “City” label within the interface element (1562). The identification “City” may indicate that the issue is to be resolved by the city in which the worksite is located, e.g., a sewer or plumbing lined owned by the city. The user interface (1500) further includes the element (1571) to remind the user to send a message to the customer about the issue that has been identified.

Turning to FIG. 16, the user interface (1600) is updated from the user interface (1300) of FIG. 13. The user interface (1600) is updated to show selection of the “Other” label within the interface element (1662). The identification “Other” may indicate that the issue was caused by one organization and is to be resolved by another organization. For example, the identification of “Other” may be selected when the company that installs plumbing discovers an issue caused by another company, and the issue is repaired by the plumbing company.

The user interface (1600) further includes the interface element (1673). The interface element (1673) captures a selection from the user for whether the work needed to resolve the issue portrayed in the evaluation picture (1645) requires an external purchase order (EPO) before the work to resolve the issue at the worksite.

Turning to FIG. 17, the user interface (1700) is updated from the user interface (1400) of FIG. 14 after selection of the button (1463). The user interface (1700) returns to a live camera view that includes the evaluation thumbnail (1747) with the thumbs down icon (1749). The evaluation thumbnail (1747) includes the markup (the red circle) within the image.

Turning to FIG. 18, the user interface (1800) is updated from the user interface (1700) of FIG. 17 after selection of the button (1842). Responsive to selection of the button (1842), the user interface (1800) displays the interface element (1875) to save the evaluation video captured by the user device.

Turning to FIG. 19, the user interface (1900) is updated from the user interface (1800) of FIG. 18 after selection of the interface element (1978). Responsive to selection of the interface element (1978), the keyboard element (1970) is displayed and the interface element (1978) is enabled to receive text.

Turning to FIG. 20, the user interface (2000) is updated from the user interface (1900) of FIG. 19. Display of the keyboard element (1970) is removed and the button (2080) is enabled. Selection of the button (2080) saves the evaluation video, evaluation picture, contextual data, markup data, etc., to nonvolatile storage. The evaluation video, evaluation picture, contextual data, markup data, etc., may also be transmitted to a server for storage to a repository.

Turning to FIG. 21, the user interface (2100) is updated from the user interface (2000) of FIG. 20. Updates to the user interface (2100) are updated in response to selection of the button (2080) of FIG. 20. As part of the update, the interface element (2185) is displayed to inform the user that the evaluation video has been saved. The user interface (2100) includes the thumbnail (2122) for the evaluation video and the thumbnail (2147) for the evaluation picture.

Turning to FIG. 22, the user interface (2200) is displayed after the evaluation video is captured and stored. The user interface (2200) includes the interface element (2288), which is displayed with the interface elements (2290), (2292), and (2295). Selection of the interface element (2290) may display the evaluation video identified in the interface element (2290).

The interface element (2290) includes a thumbnail for the evaluation video with metadata about the evaluation video. The metadata of the evaluation video displays the length of time of the evaluation video as well as the date and time the evaluation video was saved. Selection of the interface element (2290) may display the evaluation video identified in the interface element (2290).

The interface element (2292) includes a thumbnail of the evaluation picture captured from the evaluation video. The thumbnail is displayed with an overlay of distance information indicating the evaluation picture from which the evaluation thumbnail was extracted was taken when the camera of the camera device (e.g., a camera of a pipe inspection device) was extended three feet into the pipe when the evaluation picture was captured. Additional data is provided to indicate that the type is identified as “Other” and that an EPO is to be requested and saved to the system before work is to be done to resolve the issue documented with the information displayed in the interface element (2288). Selection of the interface element (2292) may display the evaluation picture identified in the interface element (2292). The interface element (2292) displays the description for the issue of the interface element (2288) as being a “Hard stoppage”.

The interface element (2295) is also displayed as a place holder within the interface element (2288). Selection of the interface element (2295) may initiate recording of a review video, which is to be recorded after the work has been performed.

Turning to FIG. 23, the user interface (2300) is updated from the interface (2200) of FIG. 22. The user interface (2300) is updated to include the interface element (2302) in addition to the interface element (2388). The interface element (2302) includes the interface elements (2305), (2308), and (2310).

The interface element (2305) displays a thumbnail for the evaluation video for the issue identified with the interface element (2302). The evaluation video of the interface element (2305) may be the same as the evaluation video of the interface element (2390).

The interface element (2308) displays a thumbnail for the evaluation picture for the issue identified with the interface element (2302). The overlay of the thumbnail in the interface element of (2308) for the evaluation picture indicates that the evaluation picture was captured when the camera device was extended eight feet within the pipe. The interface element (2308) displays the description for the issue of the interface element (2302) as being a “Cracked pipe”.

Turning to FIG. 24, the user interface (2400) may be displayed in response to selection of the interface element (2390) of FIG. 23. The user interface (2400) displays the evaluation video with the interface element (2412). The interface element (2412) displays distance information captured with the evaluation video. Alternative embodiments may not have, use, or display distance information.

Here, the distance information identifies the distance to which the camera is extended into the pipe being inspected. The icon (2415), shown as a blue diamond, indicates the location of the camera within the pipe. The icon (2418), shown as a red square or flag, indicates the location of the camera within the pipe where the issue was identified, which is about three feet into the pipe. The icon (2420), which is a play icon, is overlaid onto the thumbnail (2422) and indicates that the evaluation video, which corresponds to the thumbnail (2422), is currently being played on the user device.

Turning to FIG. 25, the user interface (2500) is updated from the user interface (2400) of FIG. 24. The user interface (2500) includes updates to the interface element (2512) and the thumbnail (2522). The interface element (2512) is updated to have the icon (2515) (a blue diamond) shown at the eight foot mark to indicate that the camera is located about eight feet within the pipe evaluation video portrayed in the evaluation video. The overlay to the thumbnail (2522) is updated with the icon (2520), which is a pause icon, showing that the playback of the video is currently paused.

Turning to FIG. 26, the user interface (2600) may be displayed in response to selection of the interface element (2392) of FIG. 23. The user interface (2600) displays the evaluation picture (2625) with the interface element (2658). The interface element (2658) may be used to edit the contextual information corresponding to the evaluation picture (2625) after selecting the button (2627).

Turning to FIG. 27, the user interface (2700) may be displayed in response to selection of the interface element (2627) of FIG. 26. Selecting the interface element (2728) enables editing of the description text for the evaluation picture (2725).

Turning to FIG. 28, the user interface (2800) may be displayed in response to selection of the interface element (2295) of FIG. 22 to capture a review video. The user interface (2800) is similar to the user interface (600) of FIG. 6 used to record the evaluation video. The user interface (2800) displays a live camera feed in the camera view (2830). The camera device generating the live camera feed may be different from the camera device used to record the evaluation video. Further, the user device presenting the user interface (2800) may be a different user device than the one used to record the evaluation video. The user device that recorded the evaluation video may be referred to as an evaluation device and the user device that captures the review video may be referred to as a review device.

The user interface (2800) includes the interface element (2825). The interface element (2825) includes the button (2828) that may be selected to begin recording the review video. The interface element (2825) also includes the interface element (2830), which is grayed out to indicate that the video is not being recorded. The interface element (2830) also includes time information “00:00” to indicate that no video has been recorded.

The user interface (2800) includes the item view (2813). The item view (2813) displays the address of the worksite (“694 N Wagon Court”) and the name of the checklist item (“TV 3″ Main Sewer Line”) being acted upon. The item view (2813) includes the interface element (2814).

The interface element (2814) corresponds to the interface element (2292) of FIG. 22 and displays information about the issue identified with the interface element (2392). The interface element (2814) includes a large thumbnail (2815) of the evaluation picture from the interface element (2292) of FIG. 22. The large thumbnail (2815) includes the markup, overlay, and watermarks incorporated into the evaluation picture. The interface element (2814) indicates that the issue is “1/1” with respect to the number of issues identified for the evaluation video of the interface element (2290) of FIG. 22. The interface element (2814) includes the description text for the issue (“Hard Stoppage”) and the distance information (“3 ft”) for where the issue occurred.

The user interface (2800) also includes the icon (2827). The icon (2827) is a placeholder icon for a thumbnail of the review video.

Turning to FIG. 29, the user interface (2900) is updated from the user interface (2800) of FIG. 28 and may be displayed after selection of the button (2828) of FIG. 28. The interface element (2925) is updated from the interface element (2825) of FIG. 28. The interface element (2925) includes the buttons (2938), (2940), and (2942) with the status element (2930). Selection of the button (2938) labeled “Take Photo” captures an image from a live view of the camera displayed in the camera view (2915). Selection of the button (2940) labeled “Pause” pauses the recording of the review video. Selection of the button (2942) labeled “End Video” stops the recording of the review video. The status element (2930) is colored red to indicate that recording is in progress and includes a time value to identify the duration of the current recording for the review video.

The user interface (2900) displays the camera view (2915) with the interface element (2912). The interface element (2912) displays distance information. The distance information identifies the distance to which the camera is extended into the pipe being inspected. The icon (2916), shown as a blue diamond, indicates the location of the camera within the pipe. The interface element (2918) includes a label and indicates the location of the issue identified in the evaluation video, which is about three feet into the pipe.

In an embodiment, the user interface (2900) may be responsive to audible commands. For example, the user may say “take photo”, “pause”, or “end video” to select the buttons (2938), (2940), and (2942) without touching the buttons (2938), (2940), and (2942).

Turning to FIG. 30, the user interface (3000) is updated from the user interface (2900) of FIG. 29. The interface element (3012) is updated to show the icon (3016) at the two foot mark to indicate the camera is extended two feet into the pipe. The distance information (3020) in the camera view (3015) is also updated to indicate the camera is extended two feet into the pipe. The border (3023) is colored orange to indicate that the camera is near the location of the issue identified with the interface element (3018) (shown in orange) at three feet. In an embodiment, the border (3023) changes to orange when the location of the camera is within 1.5 feet of the location of the issue. Different embodiments may user different lengths (1 foot, 1.9 feet, 2.2 feet, etc.) for when the border changes to the orange color.

Turning to FIG. 31, the user interface (3100) is updated from the user interface (3000) of FIG. 30. The interface element (3112) is updated with the location of the icon (3116) is updated to be at the location of the interface element (3118) to indicate the camera is at the location of the issue. The distance information (3120) is also updated to show the camera is extended three feet within the pipe. The border (3123) surrounding the camera view (3115) and the interface element (3118) are updated to be displayed with the color red to indicate that the camera is at (or beyond) the location of the issue.

The user interface (3100) also includes the interface element (3127) near the icon (3126) to prompt the user with a message to take a photo of the repair using the button (3138). In an embodiment, the interface element (3127), the red color for the border (3123), and the interface element (3118) may be shown when the location of the camera is within about 0.1 feet of the location of the issue recorded with the evaluation video. Different embodiments may use a different length (0.01 feet, 0.2 feet, 0.25 feet, etc.) for when the border changes to the red color.

Turning to FIG. 32, the user interface (3200) may be displayed after selection of the button (3138) from FIG. 31. The user interface (3200) is updated to display the review picture (3245). The interface element (3225) is updated to include the buttons (3248), (3250), and (3252). Selection of the button (3248) with a green-colored thumbs up icon indicates that the review picture (3245) does not include any issues. Selection of the button (3250) labeled “Retake” discards the current picture so that another picture may be captured. Selection of the button (3252) with a red-colored thumbs down icon indicates that the review picture (3245) includes an issue with the element being inspected.

In an embodiment, the user interface (3200) may be responsive to audible commands. For example, the user may say “thumbs up”, “retake photo”, or “thumbs down” to select the buttons (3248), (3250), and (3252) without touching the buttons (3248), (3250), and (3252).

The review picture (3245) is extracted from the video (either imported or live). The review picture (3245) may include overlay data and watermarks. The overlay data is placed at the top of the review picture and includes information about the worksite, which includes the physical address, the name of the community where the worksite is located, the name of the builder for the community, a timestamp, and identifier for the crew that performed the work being inspected, and an identifier for the person operating the user device. The watermarks are placed at the bottom left and bottom right corners of the review picture and may identify the vendor of the application, the builder, the organization performing the work, etc.

The user interface (3200) is also updated to display the review thumbnail (3247). Display of the review thumbnail (3247) replaces the display of the empty thumbnail icon (3126) of FIG. 31. The review thumbnail (3247) is a reduced resolution version of the review picture (3245). Multiple thumbnails may be provided when multiple review pictures are captured using the system.

Turning to FIG. 33, the user interface (3300) is displayed after selection of the button (3248) from FIG. 32. The user interface (3300) is updated to shift the review picture (3345), display the interface elements (3355) and (3358), and update the button (3348).

The color of the button (3348) from the light green of the button (3248) of FIG. 32 to a darker shade of green to indicate that the issue is resolved. Additionally, the review thumbnail (3347) is updated from the review thumbnail (3247) of FIG. 32 to include the thumbs up icon (3349) displayed in green on the top right corner of the review thumbnail (3347).

The interface element (3355) is a notification bar with the prompt “Circle Repaired Area”. The prompt directs the user to mark up the review picture (3345) with a circle around the area in the picture that portrays the issue identified at the worksite.

The interface element (3358) is a dialog box with several interface elements for collecting information from the user. The interface element (3358) includes the interface element (3360) to receive a textual description of the repair to the issue.

Turning to FIG. 34, the user interface (3400) is displayed after the user marks up the review picture (3445). The user interface (3400) is updated to display the markup (3465) and the button (3468).

The markup (3465) may also be referred to as a highlight. The markup (3465) is a green hand-drawn circle around a portion of the review picture (3445). The markup (3465) identifies the location of the resolution portrayed within the review picture (3445) to the issue identified in an evaluation picture. Different colors may be used.

The button (3468) is displayed responsive to display of the markup (3465) and in place of the interface element (3355) from FIG. 33. The button (3468) is displayed after the device receives markup data. Selection of the button (3468) may remove the markup (3465), remove display of the button (3468), and trigger the interface element (3355) from FIG. 33 to be redisplayed.

Turning to FIG. 35, the user interface (3500) is updated from the user interface (3400) of FIG. 34. The user interface (3500) is updated to display the keyboard element (3570). The user may operate the keyboard element (3570) to input text to the interface element (3560).

Turning to FIG. 36, the user interface (3600) is updated from the user interface (3500) of FIG. 35. The user interface (3600) is updated to remove display of the keyboard element (3570) of FIG. 35 and to update the interface element (3660). The interface element (3660) is updated to include text to describe the issue portrayed in the evaluation picture (3645). The text “Stoppage cleared” indicates that stoppage in the pipe being viewed is cleared. Other types of repairs and issues may be identified. After the text is received in the element (3660), the button (3663) is enabled. Selection of the button (3663) saves the evaluation picture (3645) with the markup and contextual data provided by the user to the system.

Turning to FIG. 37, the user interface (3700) is updated from the user interface (3600) of FIG. 36 after selection of the button (3663). The user interface (3700) returns to a live camera view that includes the evaluation thumbnail (3747) with the thumbs up icon (3749). The icon (3718) is updated to display green text on a white background to indicate resolution of the issue.

Turning to FIG. 38, the user interface (3800) is updated from the user interface (3700) of FIG. 37 after selection of the button (3842). Responsive to selection of the button (3842), the user interface (3700) displays the interface element (3875) to save the review video captured by the user device.

Turning to FIG. 39, the user interface (3900) is updated from the user interface (3800) of FIG. 38 after selection of the interface element (3978). Responsive to selection of the interface element (3978), the keyboard element (3970) is displayed and the interface element (3978) is enabled to receive text. In an embodiment, the user may select the microphone button on the keyboard element (3970) to convert speech to text to fill in the interface element (3970).

Turning to FIG. 40, the user interface (4000) is updated from the user interface (3900) of FIG. 39. Display of the keyboard element (3970) is removed and the button (4080) is enabled. Selection of the button (4080) saves the review video, review picture, contextual data, markup data, etc., to nonvolatile storage. The review video, review picture, contextual data, markup data, etc., may also be transmitted to a server for storage to a repository.

Turning to FIG. 41, the user interface (4100) is updated from the user interface (4000) of FIG. 40. Updates to the user interface (4100) are updated in response to selection of the button (4080) of FIG. 40. As part of the update, the interface element (4185) is displayed to inform the user that the review video has been saved. The user interface (4100) includes the thumbnail (4122) for the review video and the thumbnail (4147) for the review picture.

Turning to FIG. 42, the user interface (4200) is updated from the user interface (2300) of FIG. 23. The interface element (4288) is above the interface element (4202) and provides access to the evaluation video and evaluation picture (e.g., the element (4292) provides access to the evaluation picture). The interface element (4288) is updated to include the interface element (4212), which includes the interface elements (4215) and (4218).

The interface element (4215) includes a thumbnail for the review video with metadata about the review video. The metadata of the review video displays the length of time of the review video as well as the date and time the review video was saved. Selection of the interface element (4215) may display the review video identified in the interface element (4215).

The interface element (4218) includes a thumbnail of the review picture captured from the review video. The thumbnail is displayed with an overlay of distance information indicating the review picture from which the review thumbnail was extracted was taken when the camera of the camera device (e.g., a camera of a pipe inspection device) was extended three feet into the pipe when the review picture was captured. Selection of the interface element (4218) may display the review picture identified in the interface element (4218).

Turning to FIG. 43, the user interface (4300) may be displayed after selection of either of the interface elements (4292) or (4218). The user interface (4300) is displayed in portrait mode. The user interface (4300) includes the comparison view (4320). The comparison view (4320) includes the evaluation picture (4322) and the review picture (4325). The evaluation picture (4322) is depicted with a red side border labeled “BEFORE”, a red markup circle, and a red thumbs down icon. The review picture (4325) is depicted with a green side border labeled “AFTER”, a green markup circle, and a green thumbs up icon. The comparison view (4320) provides a vertical side-by-side comparison of the pipe at the same location to show the resolution of the issue identified in the evaluation picture (4322).

Turning to FIG. 44, the user interface (4400) may be displayed after selection of either of the interface elements (4292) or (4218). The user interface (4300) is displayed in a landscape mode. The user interface (4400) includes the comparison view (4420). The comparison view (4420) includes the evaluation picture (4422) and the review picture (4425). The evaluation picture (4422) is depicted with a red top border labeled “BEFORE”, a red markup circle, a red thumbs down icon. The review picture (4425) is depicted with a green top border labeled “AFTER”, a green markup circle, and a green thumbs up icon. The comparison view (4420) provides a horizontal side-by-side comparison of the pipe at the same location to show the resolution of the issue identified in the evaluation picture (4422).

Turning to FIG. 45, the user interface (4500) is updated from the user interface (4200) of FIG. 42. The interface element (4502) of user interface (4500) is updated to include the interface element (4528). The interface element (4528) includes the interface elements (4530) and (4532). The interface elements (4530) and (4532) provide access to the review video and review picture that show resolution of the issue identified with the evaluation video and picture of the interface element (4502).

The user interface (4500) also includes the interface element (4535). The interface element (4535) includes a message to the user to inform the user that the issues have been repaired and prompts the user to generate a final video of the element (i.e., the pipe).

Turning to FIG. 46, the user interface (4600) is updated from the user interface (4500) of FIG. 45. The user interface (4600) is updated to include the interface element (4635) after capturing a video (which may be referred to as a final video) after the resolution of the issue been verified. Selecting the interface element (4635) may start playback of the final video corresponding to the interface element (4635). With each of the repairs completed and documented with evaluation videos, review videos, and a final video, the user may select the button (4638) labeled “Submit” to indicate that the work items (e.g., the recording of videos) are complete. Selection of the button (4637) or the button (4636) labeled “<Back” may trigger the display of the user interface (4700) of FIG. 47.

Turning to FIG. 47, the user interface (4700) is updated from the user interface (500) of FIG. 5. The user interface (4700) may be displayed in response to selection of the button (4636) or the button (4637) of FIG. 46. The checklist item (4710) of the user interface (4700) is updated to indicate that performance of the tasks within the checklist item (4710) are “IN PROGRESS” and is displayed with an orange color.

Turning to FIG. 48, the user interface (4800) is updated from the user interface (4700) of FIG. 47. The user interface (4800) may be displayed after the button (4638) of FIG. 46 is selected. The user interface (4800) is updated to indicate that performance of the tasks within the checklist item (4710) are “COMPLETE” and is displayed with a green color. The user interface (4800) is also updated to include the notification message (4845), which indicates that the checklist item (4810) has been completed.

Turning to FIG. 49, the user interface (4900) is updated from the user interface (4800) of FIG. 48. The user interface (4900) is updated to remove the notification message (4845) of FIG. 48 after a predetermined length of time or after closing the notification message (4845). For example, the notification message (4845) may be removed after being displayed for 15 seconds. Other lengths of time may be used.

Turning to FIG. 50, the user interface (5000) is updated from the user interface (4900) of FIG. 49. The user interface (5000) is updated to change the statuses displayed by the checklist items (5012) and (5015) to indicate the additional work has been performed. The interface element (5012) is updated to be displayed in a red color with an icon and text to indicate that the performance of the tasks within the checklist item (5012) are “INCOMPLETE”. The interface element (5015) is updated to be displayed in a green color with an icon and text to indicate that the performance of the tasks within the checklist item (5015) are “COMPLETE”.

Turning to FIG. 51, the user interface (5100) is displayed after selecting the checklist item (5012) of FIG. 50. The user interface (5100) shows a hierarchical list with several issues to be resolved before the checklist item (5012) of FIG. 50 may be marked as complete. The hierarchical list includes the list items (5120) and (5128).

The list item (5120) is for the task identified as “TV 4″ Sewer Main Line”, which has two unresolved issues. The two unresolved issues are documented with the interface elements (5122) and (5125). The interface elements (5122) and (5125) include evaluation videos and evaluation pictures but the work to resolve the issues has not been documented in review videos or review pictures.

The list item (5128) is for the task identified as “TV Outside Cleanouts Back”, which has one unresolved issue documented with the interface element (5130). The interface element (5130) includes an evaluation video but not a review video.

Turning to FIG. 52, the user interface (5200) is updated from the user interface (5100) of FIG. 51. The checklist item (5220) includes the interface elements (5222) and (5225) and is displayed above the checklist item (5232). The interface element (5222) is updated after the capture of addition videos and pictures to include the interface element (5223) and the interface element (5225) is updated to include the interface element (5226). The interface element (5223) includes additional interface elements for the review video and review picture that document the repairs performed to resolve the issues identified and documented with the evaluation video and evaluation picture of the interface element (5222). The interface element (5226) includes additional interface elements for the review video and review picture that document the repairs performed to resolve the issues identified and documented with the evaluation video and evaluation picture of the interface element (5225). Selection of the button (5235) submits the repair verifications for the interface elements (5223) and (5226) to the server.

Turning to FIG. 53, the user interface (5300) may be displayed responsive to selection of the button (5235) of FIG. 52. The user interface (5300) displays the list (5338) and includes the notification message (5340). The notification message (5340) indicates that unresolved issues will be rescheduled. In an embodiment, the server determines upon selection of the button (5235) of FIG. 52 that the issues for the checklist item (5220) of FIG. 52 are completed but that the issues for the checklist item (5232) remain unresolved, which is reflected in the notification message (5340).

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 54A, the computing system (5400) may implement the systems and methods described in the previous figures and include one or more computer processors (5402), non-persistent storage device(s) (5404), persistent storage device(s) (5406), a communication interface (5412) (e.g., Bluetooth interface, infrared interface, network interface, optical interface, etc.), and numerous other elements and functionalities that implement the features and elements of the disclosure. The computer processor(s) (5402) may be an integrated circuit for processing instructions. The computer processor(s) may be one or more cores or micro-cores of a processor. The computer processor(s) (5402) includes one or more processors. The one or more processors may include a central processing unit (CPU), a graphics processing unit (GPU), a tensor processing unit (TPU), combinations thereof, etc.

The input device(s) (5410) may include a touchscreen, keyboard, mouse, microphone, touchpad, electronic pen, or any other type of input device. The input device(s) (5410) may receive inputs from a user that are responsive to data and messages presented by the output device(s) (5408). The inputs may include text input, audio input, video input, etc., which may be processed and transmitted by the computing system (5400) in accordance with the disclosure. The communication interface (5412) may include an integrated circuit for connecting the computing system (5400) to a network (not shown) (e.g., a local area network (LAN), a wide area network (WAN) such as the Internet, mobile network, or any other type of network) and/or to another device, such as another computing device.

Further, the output device(s) (5408) may include a display device, a printer, external storage, or any other output device. One or more of the output device(s) may be the same or different from the input device(s). The input and output device(s) may be locally or remotely connected to the computer processor(s) (5402). Many different types of computing systems exist, and the aforementioned input and output device(s) may take other forms. The output device(s) (5408) may display data and messages that are transmitted and received by the computing system (5400). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (5400) in FIG. 54A may be connected to or be a part of a network. For example, as shown in FIG. 54B, the network (5420) may include multiple nodes (e.g., node X (5422), node Y (5424)). Each node may correspond to a computing system, such as the computing system shown in FIG. 54A, or a group of nodes combined may correspond to the computing system shown in FIG. 54A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (5400) may be located at a remote location and connected to the other elements over a network.

The nodes (e.g., node X (5422), node Y (5424)) in the network (5420) may be configured to provide services for a client device (5426), including receiving requests and transmitting responses to the client device (5426). For example, the nodes may be part of a cloud computing system. The client device (5426) may be a computing system, such as the computing system shown in FIG. 54A. Further, the client device (5426) may include and/or perform all or a portion of one or more embodiments.

The computing system of FIG. 54A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the word “or” is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above may be devised which do not depart from the scope of the claims as disclosed herein. Accordingly, the scope should be limited only by the attached claims.

What is claimed is:

1. A method comprising:
presenting a checklist item;
receiving an evaluation video documenting an element of a worksite corresponding to the checklist item;
receiving an evaluation picture from the evaluation video, wherein the evaluation picture documents an element issue portrayed in the evaluation video;
receiving contextual data of the evaluation picture, wherein the contextual data of the evaluation picture comprises markup data of the evaluation picture; and
using the evaluation video and the evaluation picture to update the checklist item to an evaluated checklist item.

2. The method of claim 1, further comprising:
receiving a review video documenting the element issue;
receiving a review picture from the review video, wherein the review picture documents resolution of the element issue portrayed in the evaluation video.
receiving contextual data of the review picture, wherein the contextual data of the review picture comprises markup data of the review picture and the markup data of the review picture contrasts with the markup data of the evaluation picture; and
using the review video and the review picture to update the evaluated checklist item to a reviewed checklist item.

3. The method of claim 1, further comprising:
receiving the evaluation picture, wherein the evaluation picture is adjusted to include the markup data of the evaluation picture, one or more watermarks of the evaluation picture, and one or more overlays of the evaluation picture comprising overlay data of the evaluation picture; and
receiving a review picture, wherein the review picture is adjusted to include markup data of the review picture, one or more watermarks of the review picture, and one or more overlays of the review picture comprising overlay data of the review picture.

4. The method of claim 1, further comprising:
receiving a selection of the checklist item presented in a user interface.

5. The method of claim 1, further comprising:
presenting a camera view responsive to a selection of the checklist item, wherein the camera view is displayed on an evaluation device to record the evaluation video.

6. The method of claim 1, further comprising:
presenting a playback view responsive to a selection of the checklist item, wherein the playback view displays one or more of the evaluation video and a review video.

7. The method of claim 1, further comprising:
presenting embedded information in one or more of a camera view and a playback view with one or more of the evaluation video and a review video.

8. The method of claim 1, further comprising:
presenting a verification view using the evaluation video and the evaluation picture with an interface element to initiate recording a review video.

9. The method of claim 1, further comprising:
presenting a verification view using the evaluation video, the evaluation picture, a review video, and a review picture.

10. The method of claim 1, further comprising:
presenting a verification view using the evaluation picture and a review picture with embedded data overlaid onto a thumbnail of the evaluation picture and a thumbnail of the review picture.

11. A system comprising
at least one processor and
an application that, when executing on the at least one processor, performs:
presenting a checklist item;
receiving an evaluation video documenting an element of a worksite corresponding to the checklist item;
receiving an evaluation picture from the evaluation video, wherein the evaluation picture documents an element issue portrayed in the evaluation video;
receiving contextual data of the evaluation picture, wherein the contextual data of the evaluation picture comprises markup data of the evaluation picture; and
using the evaluation video and the evaluation picture to update the checklist item to an evaluated checklist item.

12. The system of claim 11, wherein the application further performs:
receiving a review video documenting the element issue;
receiving a review picture from the review video, wherein the review picture documents resolution of the element issue portrayed in the evaluation video.
receiving contextual data of the review picture, wherein the contextual data of the review picture comprises markup data of the review picture and the markup data of the review picture contrasts with the markup data of the evaluation picture; and
using the review video and the review picture to update the evaluated checklist item to a reviewed checklist item.

13. The system of claim 11, wherein the application further performs:
receiving the evaluation picture, wherein the evaluation picture is adjusted to include the markup data of the evaluation picture, one or more watermarks of the evaluation picture, and one or more overlays of the evaluation picture comprising overlay data of the evaluation picture; and
receiving a review picture, wherein the review picture is adjusted to include markup data of the review picture, one or more watermarks of the review picture, and one or more overlays of the review picture comprising overlay data of the review picture.

14. The system of claim 11, wherein the application further performs:
receiving a selection of the checklist item presented in a user interface.

15. The system of claim 11, wherein the application further performs:
presenting a camera view responsive to a selection of the checklist item, wherein the camera view is displayed on an evaluation device to record the evaluation video.

16. The system of claim 11, wherein the application further performs:
presenting a playback view responsive to a selection of the checklist item, wherein the playback view displays one or more of the evaluation video and a review video.

17. The system of claim 11, wherein the application further performs:
presenting embedded information in one or more of a camera view and a playback view with one or more of the evaluation video and a review video.

18. The system of claim 11, wherein the application further performs:
presenting a verification view using the evaluation video and the evaluation picture with an interface element to initiate recording a review video.

19. The system of claim 11, wherein the application further performs:
presenting a verification view using the evaluation video, the evaluation picture, a review video, and a review picture.

20. A non-transitory computer readable medium comprising instructions that, when executed by one or more processors, perform:
presenting a checklist item;
receiving an evaluation video documenting an element of a worksite corresponding to the checklist item;
receiving an evaluation picture from the evaluation video, wherein the evaluation picture documents an element issue portrayed in the evaluation video;
receiving contextual data of the evaluation picture, wherein the contextual data of the evaluation picture comprises markup data of the evaluation picture; and
using the evaluation video and the evaluation picture to update the checklist item to an evaluated checklist item.
